(19) United States
(12) Patent Application Publication
(10) Pub. No.: US 2022/0299154 A1
(43) Pub. Date: Sep. 22, 2022

(54) Thermoplastic Vulcanizate Compositions and Thermoplastic Olefinic Compositions as Insulating Layers in Non-Flexible Pipes

(71) Applicant: Celanese International Corporation, Irving, TX (US)

(72) Inventors: Krishnan Anantha Narayana Iyer, Pearland, TX (US); Antonios K. Doufas, Houston, TX (US); Anthony J. Dias, Houston, TX (US); Deborah J. Davis, League City, TX (US); Warren P. Jones, Missouri City, TX (US); Wanli Wang, Katy, TX (US); Krassimir I. Doynov, Houston, TX (US); Gregory R. Ruschau, The Woodlands, TX (US); Sunny Jacob, Seabrook, TX (US)

(21) Appl. No.: 17/638,525

(22) PCT Filed: Aug. 14, 2020
(86) PCT No.: PCT/US2020/046290

§ 371 Date: Feb. 25, 2022

Related U.S. Application Data
(60) Provisional application No. 62/891,607, filed on Aug. 26, 2019.

(51) Int. Cl. F16L 59/02; F16L 59/14; F16L 58/10; C08L 23/20; C08L 71/02; C08L 9/00; C08L 23/06

(52) U.S. Cl. CPC F16L 59/029; F16L 59/14; F16L 58/109; C08L 23/20; C08L 71/02; C08L 9/00; C08L 23/06; C08L 2312/00; C08L 2205/20; C08L 2207/062

(57) ABSTRACT

In an embodiment is provided a composition having a thermal conductivity of less than 0.2 W/m-K, the composition including a rubber and a thermoplastic olefin. In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition having a thermal conductivity of less than 0.2 W/m-K, the composition comprising a rubber and a thermoplastic olefin.

### CROSS-REFERENCE TO RELATED APPLICATIONS

This application claims the priority benefit of U.S. Ser. No. 62/891,607, filed Aug. 26, 2019, which is incorporated herein by reference.

### FIELD

Embodiments of the present disclosure generally relate to thermoplastic vulcanizate (TPV) compositions, to insulating layers comprising TPV compositions, and to the use of such layers in fluid and/or gas transport pipes. Embodiments of the present disclosure also generally relate to thermoplastic olefinic (TPO) compositions, to insulating layers comprising TPO compositions, and to the use of such layers in fluid and/or gas transport pipes.

### BACKGROUND

The oil and gas industry has been on the lookout for higher performance thermal insulation layers to protect off-shore transport pipes operating at temperatures up to and above 130° C., or higher, in water depths above 1,000 meters. In order to maintain the pipe at the required operating temperatures at these depths, the insulation layer must have low thermal conductivity to prevent the formation of hydrates and waxes that can compromise flow integrity. One of the most common approaches to reduce thermal conductivity of insulation layer include the incorporation of glass beads or glass microspheres known as glass syntactic foams. Although, such approaches to reduce thermal conductivity have proven successful to some degree for shallow water depth this has proven insufficient for greater water depths (e.g., greater than 1000 m) due to compressive creep and rupture of glass beads under excessive pressures. The materials used in such applications should also exhibit various properties, e.g., high softening point, high thermal stability, and high compressive creep resistance in order to withstand the operating temperatures and hydrostatic pressures acting on the coating in deep water pipe installations. Without sufficient compressive strength, the insulation will be compressed in thickness and resultant rupture of glass beads, thereby increasing thermal conductivity and altering the dimensions and the thermal and hydrodynamic performance of the system. In addition to thermal conductivity, the insulating layer should remain sufficiently ductile after application to the pipe to prevent cracking during pipe handling and installation, for example during reeling onto a lay barge and subsequent deployment therefrom. Ductility of insulation material is also crucial in preventing cracking during reel-lay particularly under low installation temperature.

Conventional insulating technologies suffer from various limitations and deficiencies including: (1) the relatively high thermal conductivity of known insulating systems, which requires thick layers to achieve the required insulation performance, resulting in difficulties in foam/glass bead processing, potential for residual stress, difficulties in pipe deployment, and sea-bed instability; (2) High application cost associated with glass syntactic polypropylene foams due to high application process time and poor material recyclability (3) High k-value under aged conditions due to rupture of glass beads particularly at greater depths; (4) Insufficient resistance to temperatures above 130° C., resulting in compression and creep resistance issues in high temperature installations at high water depths; (5) Compression and creep resistance issues at high water depth leading to a change in buoyancy posing significant challenges in system design; (6) Excessive costs due to poor material cost versus performance capabilities or high transportation and deployment costs; and (7) Deployment and operation disadvantages with pipe-in pipe systems due to weight factors leading to buckling and weld failure if not properly addressed, and the need for high gripping loads during pipe laying.

In addition, current insulation systems use a multilayer approach (e.g., a 5 layer polypropylene (PP) system and 3 layer PP system), where an adhesive layer is placed between a PP topcoat layer and the thermal insulation layer. This adhesive layer presents an additional cost as well as a potential point of failure in the current insulation systems.

Although the polystyrene-based insulation systems disclosed in International Publication No. WO 2009/079784A1 by Jackson et al. provide improved thermal performance over known insulation systems at operating temperatures up to about 100° C., these polystyrene-based systems generally have insufficient resistance to temperatures above 130° C. Additionally, the polystyrene-based insulation systems are known to possess poor low temperature flexibility exacerbating low temperature cracking during reel-lay.

Multi-layer, glass-syntactic (GS), polypropylene thermal insulation systems, applied as an outer layer around non-flexible (currently metallic or in future fully-bonded, multi-layer, thermoplastic composite) pipes conveying oil and/or gas production in subsea service for flow assurance purposes, have multiple limitations: (1) A reduced application process rate of the GS layer because of the glass microsphere additive, resulting in higher viscosity and glass microsphere breakage at high shear conditions; (2) an increased extrusion tooling wear rate with the GS layer because of the abrasive nature of glass microsphere additive; (3) an increased process complexity, longer setup and changeover times due to the glass microsphere additive; (4) a reduced thermal resistance at the insulation applied over welded pipe joints in the field due to the removal of glass microsphere additive to enable application by injection molding; (5) an increased susceptibility to cracking during reel-lay installation at or near the interface between the factory-applied material on the pipe body and the field-applied material over welded joints because of the mechanical property differences and the low tensile elongation limit of the material in the GS layer; (6) the rate of cracking in (5) increases with reel-lay installation in colder weather; (7) an increased process cost & complexity due to the application of an outermost protective layer without a glass microsphere additive; (8) an increased misapplication risk due to the water depth dependency of the grade of glass microsphere selected; and (9) a reduced maximum application temperature capability due to hot water hydrolysis of the glass-syntactic polyurethane.

Therefore, there remains a need for improved coatings for thermal insulation and protection of fluid and/or gas transport conduits such as oil and gas pipelines, especially for off-shore transport conduits operating at high temperatures in water depths above 1,000 meters.

References for citing in an Information Disclosure Statement (37 CFR 1.97(h)) include: U.S. Pat. Nos. 8,397,765, 8,714,206, WO 2009/079784, WO 2019/125547, U.S. Patent Publication No. 2011/0297316, and U.S. Patent Publication No. 2011/0297316.

### SUMMARY

In an embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a corrosion protection coating directly applied to the outer surface of the steel pipe and bonded thereto and underlying the first thermal insulation layer, wherein the first thermal insulation layer is in direct contact with the corrosion protection coating and directly adhered thereto.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a corrosion protection coating directly applied to the outer surface of the steel pipe and bonded thereto, and underlying the first thermal insulation layer, wherein the corrosion protection coating comprises a multi-layer corrosion protection system applied to the outer surface of the steel pipe and underlying the first thermal insulation layer, wherein the multi-layer corrosion protection system comprises: a layer of cured epoxy or modified epoxy directly applied to the outer surface of the steel pipe and bonded thereto; and a first adhesive layer applied directly to the corrosion protection layer and underlying at least a portion the first thermal insulation layer.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and an outer protective topcoat applied over the first thermal insulation layer and forming an outer surface of the insulated transport conduit, wherein the outer protective topcoat comprises an unfoamed polymeric material, and wherein the first thermal insulation layer is in direct contact with the outer protective topcoat and directly adhered thereto.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and an outer protective topcoat applied over the first thermal insulation layer and forming an outer surface of the insulated transport conduit, wherein the outer protective topcoat comprises an unfoamed polymeric material, and wherein the first thermal insulation layer is in direct contact with the outer protective topcoat and directly adhered thereto.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a second thermal insulation layer comprising a second composition in the form of a solid, a blown foam or a syntactic foam, the second composition comprising a rubber and a thermoplastic olefin, wherein the first and second thermal insulation layers are foamed to different degrees.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a second thermal insulation layer comprising a second composition in the form of a solid, a blown foam or a syntactic foam, the second composition comprising a rubber and a thermoplastic olefin, wherein the first and second thermal insulation layers are foamed to different degrees, wherein the first thermal insulation layer underlies the second thermal insulation layer, and is in direct contact with the second thermal insulation layer and directly adhered thereto.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a second thermal insulation layer comprising a second composition in the form of a solid, a blown foam or a syntactic foam, the second composition comprising a rubber and a thermoplastic olefin, wherein the first and second thermal insulation layers are separated by a layer of unfoamed polymeric material.

In another embodiment is provided an insulated high-temperature transport conduit that includes a continuous steel pipe comprising one or more pipe sections, wherein the steel pipe has an outer surface and an inner surface; a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and a molded pipe joint insulation system directly bonded to both the corrosion protection coating system and first thermal insulation layer at a joint connecting two pipe sections.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin, the rubber is at least partially crosslinked.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin, the rubber is substantially free of crosslinks.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein the first thermal insulation layer comprises a composition that is resistant to degradation in hot water, the hot water being at a temperature greater than 100° C., the composition comprising a rubber and a thermoplastic olefin.

In another embodiment is provided an insulated high-temperature transport conduit that includes a continuous steel pipe comprising one or more pipe sections, wherein the steel pipe has an outer surface and an inner surface; and a first thermal insulation layer disposed over the outer surface of the steel pipe, wherein: the first thermal insulation layer comprises a composition that is resistant to degradation in hot water, the hot water being at a temperature greater than 100° C., the composition comprising a rubber and a thermoplastic olefin, and the composition is free of glass microspheres and ceramic microspheres.

Other and further embodiments are described below.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1A shows a transverse cross-section of an insulated pipe according to at least one embodiment.

FIG. 1B shows a transverse cross-section of an insulated pipe according to at least one embodiment.

FIG. 1C shows a transverse cross-section of an insulated pipe according to at least one embodiment.

FIG. 1D shows a transverse cross-section of an insulated pipe according to at least one embodiment.

FIG. 2 shows a longitudinal cross-section of a pipe joint weld area at which two pipes are joined according to at least one embodiment.

FIG. 3 shows a longitudinal cross-section of a pipe joint weld area at which two pipes are joined according to at least one embodiment.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

Embodiments of the present disclosure generally relate to TPV compositions, to insulating layers comprising TPV compositions, and to the use of such layers in fluid and/or gas transport pipes. Embodiments of the present disclosure also generally relate to thermoplastic olefinic (TPO) compositions, to insulating layers comprising TPO compositions, and to the use of such layers in fluid and/or gas transport pipes.

As noted above, conventional technology for the transport of fluid and gas suffer from many deficiencies. The inventors have discovered certain TPV compositions and TPO compositions that overcome these deficiencies.

For purposes of this disclosure, and unless otherwise indicated, the terms “conduit” and “pipe” can be used interchangeably.

The fluid and/or gas transport conduits described below can be oil and gas pipelines which are typically made up of one or more pipe (e.g., steel pipe) sections. For purposes of this disclosure, and unless otherwise indicated, the term “fluid and/or gas transport conduits”, and similar terms as used herein, include such oil and gas pipelines and related components, including flowlines, risers, jumpers, spools, manifolds and ancillary equipment.

For purposes of this disclosure, and unless otherwise indicated, a “composition” includes components of the composition and/or reaction products of two or more components of the composition.

A major consideration in the use of steel pipe is protection of the pipe from long-term corrosion in humid and high-temperature service conditions. Therefore the insulating and protective coatings according to the present disclosure may comprise one or more corrosion-protection layers or a multi-layer corrosion protection system which is applied over the blasted and cleaned steel pipe prior to the application of any subsequent layers, including the at least one layer of high temperature resistant TPV (and/or TPO) composition according to the present disclosure. For example, the corrosion protection layer may comprise a cured epoxy layer directly applied to the outer surface of the steel pipe and bonded thereto.

It will be appreciated that layers making up the insulating and protective coatings described below are not shown to scale in the drawings. In particular, the thicknesses of some of the layers making up the coatings are exaggerated in relation to the thicknesses of the other layers and also relative to the thickness and diameter of the steel pipe.

Although the embodiments of the present disclosure shown in the drawings include either one or two thermal insulation layers, it will be appreciated that insulated pipelines according to the present disclosure may include more than two layers of foamed or unfoamed thermal insulation, with or without layers of unfoamed polymer and/or adhesive being provided between the foam layers.

### Articles

Certain embodiments of the present TPV compositions and TPO compositions are used to form a layer made by extrusion and/or co-extrusion, blow molding, injection molding, thermo-forming, elasto-welding, compression molding and 3D printing, pultrusion, and other fabrication techniques. The layer can be co-extruded as a separate layer, or extruded as a tape and wrapped onto the pipe, such as an insulation layer (e.g., a thermal insulation layer) or an outer protective coating around the pipe. The layer can be part of a structure used to transport hydrocarbons extracted from an offshore deposit and/or can transport water, heated fluids, and/or chemicals injected into the formation in order to increase the production of hydrocarbons.

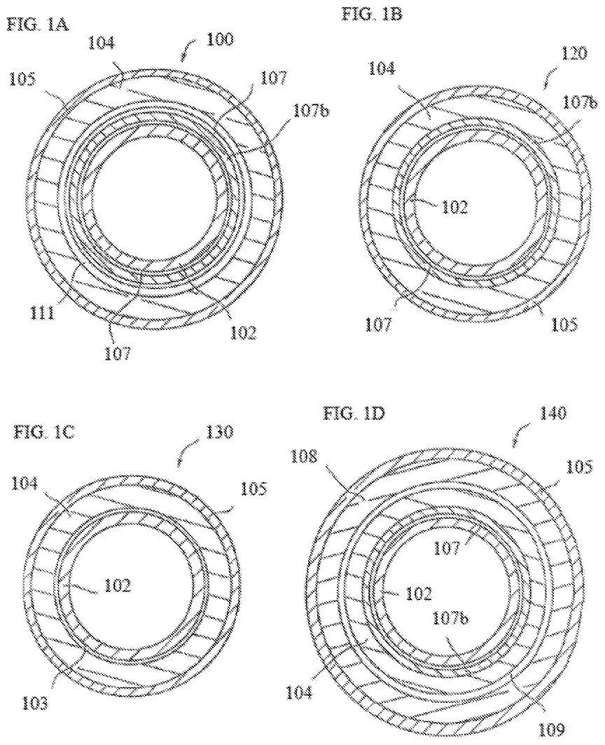

FIG. 1A shows a transverse cross-section of an insulated oil and gas pipeline 100 according to at least one embodiment of the present disclosure. The insulated pipeline 100 can include one or more sections of pipe 102 in which the insulating and protective coating includes a three-layer corrosion protection system. According to this system, the steel pipe 102 can be coated with a corrosion protection layer 107 that can include cured epoxy, and/or an intermediate first adhesive layer 107b applied over the corrosion protection layer 107, and/or a first protective topcoat 107c applied over the first adhesive layer 107b. The first protective topcoat 107c can provide added corrosion and mechanical protection and the optional adhesive layer 107b provides an adhesive bond between the topcoat 107c and the underlying corrosion protection layer 107. The topcoat 107c is shown in FIG. 1A as a thin layer between the optional adhesive layer 107b and the overlying insulation layers (e.g., 106) described below. The composition and thickness of the topcoat 107c will at least partially depend on the compositions of the underlying optional adhesive layer 107b and the overlying insulation layers, particularly with respect to adhesion to those layers. In some embodiments, a second adhesive layer 111 is optionally used. In terms of composition, the topcoat may comprise an extrudable thermoplastic resin, or may comprise the same material as an overlying thermal insulation layer, or a material compatible with or bondable to the thermal insulation layer, including a blend of two or more materials.

In some embodiments, an outer protective topcoat 105 may be applied over the outer layer of insulation to provide further resistance to static pressure at great depths, for example when said outer layer of insulation is foamed. The outer protective topcoat 105 may, for example, comprise the same polymeric material as one or more of the thermal insulation layers but can be a solid, unfoamed state. For example, where the outer layer of insulation (e.g., layer 104) comprises a foamed polystyrene, styrene-based thermoplastic, a TPV composition, or a TPO composition, and the outer protective topcoat 105 can include a solid, unfoamed polystyrene, styrene-based thermoplastic, a TPV composition, or a TPO composition.

FIG. 1B shows a transverse cross-section of an insulated oil and gas pipeline 120 according to at least one embodiment of the present disclosure. The insulated pipeline 120 includes one or more sections of steel pipe 102 provided with a two-layer corrosion protection system, wherein the steel pipe 102 is provided with a corrosion protection layer 107 comprising a cured epoxy and a first adhesive layer 107b applied over layer 107, as in FIG. 1A. In the corrosion protection system shown in FIG. 1B, the first adhesive layer 107b can double as both adhesive and topcoat, thereby eliminating the need for the separate application of a first protective topcoat 107c. A similar two-layer corrosion protection system is shown in FIG. 1D which illustrates a transverse cross-section of an insulated oil and gas pipeline 140 according to another embodiment.

As an alternative to the multi-layer corrosion protection systems illustrated in FIGS. 1A and 1B, the steel pipe 102 can instead be provided with a single-layer composite corrosion protection layer wherein the epoxy, adhesive and polymer topcoat components are pre-mixed and applied onto the pipe 1 as a variably graded coating. FIG. 1C illustrates a transverse cross-section of an insulated oil and gas pipeline 130 according to at least one embodiment of the present disclosure. The insulated pipeline 130 can include one or more sections of pipe 102 provided with such a single-layer composite corrosion protection coating 103.

In the insulated oil and gas pipelines according to some embodiments of the present disclosure, the insulating and protective coatings can include one or more thermal insulation layers, which can include one or more foamed layers and/or one or more unfoamed (solid) layers. The pipelines 100 120, and 130 illustrated in FIGS. 1A-1C include a single thermal insulation layer 104, whereas other pipelines (e.g., 140 of FIG. 1D) can be provided with first (inner) and second (outer) thermal insulation layers 104. It will also be appreciated that insulated oil and gas pipelines according to the present disclosure can include more than two layers of thermal insulation, each of which may be foamed or unfoamed.

As shown in FIG. 1D, the insulating and protective coating can comprise more than one thermal insulation layer of the same TPV composition (or TPO composition) foamed to different degrees, or densities, or it can comprise more than one thermal insulation layer of solid or foam made from dissimilar TPV materials (or TPO materials). This can allow the system to be tailored for precise thermal insulation performance related to the end application. For example, a TPV or TPO with higher temperature resistance or softening point may be used as an inner foam or solid thermal insulation layer closest to the hot steel pipe with lower temperature resistant and lower thermal conductivity TPV or TPO, as an outer secondary, or tertiary, insulation layer.

The embodiment illustrated in FIG. 1D, can include an inner foam insulation layer 104 and an outer foam insulation layer 108 which may be of the same or different composition and/or density. The foam insulation layers 104 and 108 can be separated by a layer 109 of unfoamed polymeric material which may be of the same or different composition as either one or both of the layers 104 and 108. It will be appreciated that an adhesive layer may be provided between the foam layers 104, 108 or between one or more of foam layers 104, 108 or and the adjacent unfoamed layer 109. It will be appreciated that the unfoamed layer 109 may not be necessary in all situations, for example where individual foam insulation layers are bonded directly to one another.

In at least one embodiment is provided thermal insulation around joint areas where two lengths of steel pipe are welded together. The composition of this pipe joint insulation system can be bondable to both the corrosion protection layer, or system, applied directly over the welded pipe joint and the existing thermal insulation layer, or layers, including any protective topcoats and any other layers of the insulated pipe exposed as a result of cutting back the insulation from the pipe ends to allow welding thereof.

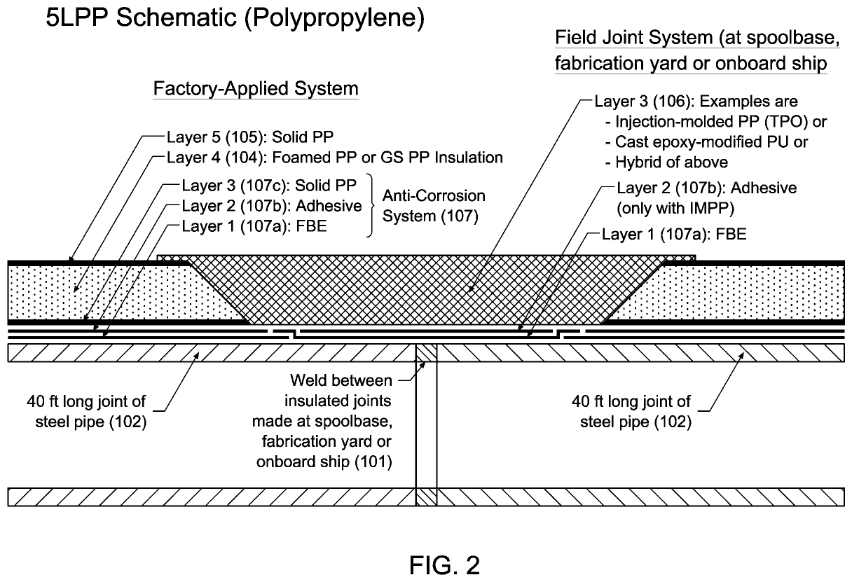

FIG. 2 shows, schematically, a longitudinal cross-section of a pipe joint weld area 101 at which two pipes 102 (e.g., steel pipes) are joined according to at least one embodiment. The steel pipes 102 can each have an insulating and protective coating comprising a corrosion protection layer 107, a thermal insulation layer 104, and an outer protective topcoat 105. The pipe joint weld area 101 can be provided with a pipe joint insulation layer 106, which, for example, can be bonded to a corrosion protection system 107, the thermal insulation layer 104, and/or the outer protective topcoat 105. The corrosion protection system 107 (also called the anti-corrosion system) can include an epoxy inner layer 107a (e.g., FBE), an adhesive layer 107b, and a polypropylene layer 107c. As a non-limiting example, the thermal insulation layer 104 can be made from or include foamed PP, glass syntactic (GS) PP insulation, a TPV composition described herein, a TPO composition described herein, or a combination thereof. As a non-limiting example, the pipe joint insulation layer 106 can be made from or include a TPV composition described herein, a TPO composition described herein, a thermoplastic polyurethane (TPU) composition described herein, a cast epoxy modified polyurethane (PU), or a combination thereof. TPV compositions and TPO compositions are described below.

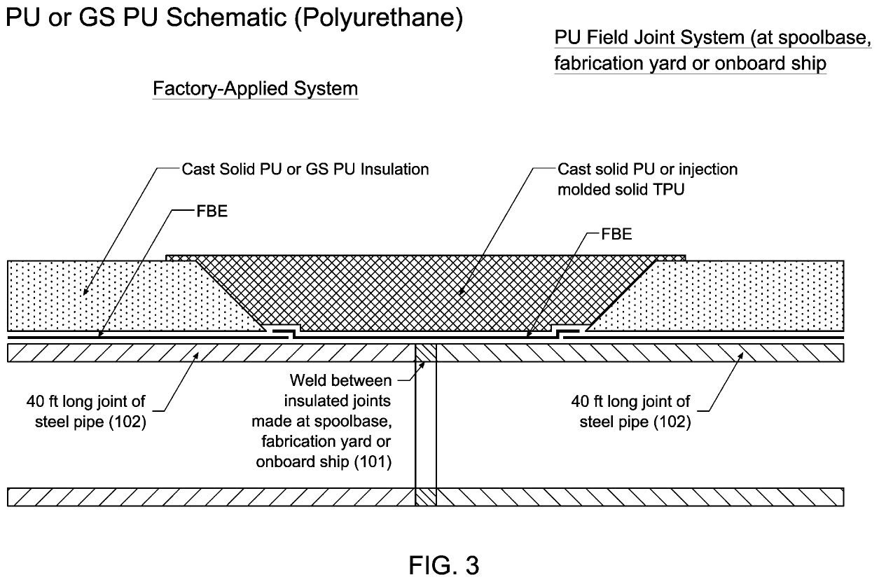

FIG. 3 shows, schematically, a longitudinal cross-section of a pipe joint weld area 101 at which two pipes 102 (e.g., steel pipes) are joined according to at least one embodiment. The steel pipes 102 can each have an insulating and protective coating comprising an epoxy layer (FBE), a thermal insulation layer (e.g., cast solid polyurethane (PU), a glass syntactic PU, a TPV composition described herein, a TPO composition described herein, or a combination thereof). The pipe joint weld area 101 can be provided with a pipe joint insulation layer (e.g., a cast solid PU, an injection molded solid TPU, a TPV composition described herein, a TPO composition described herein, or a composition thereof), which, for example, can be bonded to the epoxy layer and/or the thermal insulation layer.

In contrast to conventional systems, the insulation layer bonds directly to the PP (e.g., the PP topcoat) without the need for an adhesive. The TPV compositions and TPO compositions described herein can bond to the PP layer without using an adhesive.

Certain classes of TPVs and TPOs have been surprisingly found to provide an alternative and more robust material for the insulation layers (e.g., thermal insulation layer and/or pipe joint insulation layer 106) described herein. As discussed below, and according to some embodiments, the TPV compositions and TPOs can include a rubber phase, a thermoplastic phase, optionally a plasticizer (e.g., an oil), and optionally a curative. The rubber phase can be crosslinked, partially crosslinked, fully crosslinked, substantially free of crosslinking, and non-crosslinked, and/or cured. The thermoplastic phase can be crosslinked, partially crosslinked, fully crosslinked, substantially free of crosslinking, and non-crosslinked. In at least one embodiment, the TPV composition and TPO composition can include a high temperature thermoplastic phase, a low thermal conductivity elastomer (e.g., less than 0.2 watts per meter-Kelvin (W/m·K)), and/or a low TC processing oil. In at least one embodiment, the TPV composition and TPO composition is free of microspheres (e.g., glass microspheres and ceramic microspheres)

### Composition of Layers

### 1. Corrosion Protection Coating(s)

It can be advantageous to apply one or more corrosion protection layers or a multi-layer corrosion protection system to the steel pipe prior to any subsequent layers. The initial corrosion protection layer, namely that coating bonded directly to the steel pipe, may include a cured epoxy, or modified epoxy, which can be applied onto a cleaned and pre-heated pipe surface (a) as a fusion bonded powder by spraying the pipe with powder-spray guns, passing the pipe through a “curtain” of falling powder, or using a fluidized bed containing the powder, or, (b) as a liquid coating using liquid-spray guns. Curing of the epoxy can result from contact with the hot pipe. The cured epoxy, or modified epoxy can be applied by other methods known in the art.

It can be advantageous to apply additional layers over the partially cured epoxy. In a 3-layer corrosion protection system, an olefin-based adhesive copolymer, for example a maleic anhydride functionalized polyolefin, can be applied directly to the partially cured epoxy, followed by the application of a polymer topcoat over the adhesive for mechanical protection. The function of the adhesive is to bond the topcoat or the first thermal insulation layer to the epoxy corrosion protection layer. The adhesive and polymer topcoat may be applied by extrusion side-wrap or by powder spray methods.

The adhesive layer may also include a coextruded structure of two or more layers, the outer layers of which will bond to the respective corrosion protection layer and subsequent topcoat or thermal insulation layer with which they are compatible.

As alternatives to the cured epoxies mentioned above, the corrosion protection layer can instead (or additionally) include modified epoxies, epoxy phenolics, modified styrene-maleic anhydride copolymers such as styrene-maleic anhydride-ABS (acrylonitrile-butadiene-styrene) blends, polyphenylene sulphides, polyphenylene oxides, or polyimides, including modified versions and blends thereof. In some cases, an adhesive layer is not used to bond these corrosion protection coatings to the pipe or to the topcoat or first insulation layer. Some of these materials can also be used at higher service temperatures than the epoxy-based corrosion protection systems described above.

Some of the higher temperature-resistant corrosion protection coatings mentioned above may also have properties which make them suitable for use as thermal insulation layers in any of the embodiments of the present disclosure. While the corrosion protection coating can include a different polymer grade having different properties, it is conceivable that the same type and grade of polymer may be used for both corrosion protection and thermal insulation. In this case, a single layer of this polymer may serve as both corrosion protection coating and thermal insulation layer.

In at least one embodiment, an additional adhesive layer may not be used, when two or more layers a mutual affinity for each other, or where it is possible to achieve bonding of the layers using plasma or corona treatment.

### 2. Additional Adhesive Layer(s)

In at least one embodiment and in cases where an adhesive layer is used, e.g., where an adhesive layer is applied between adjacent thermal insulation layers or between a thermal insulation layer and one or more of the other layers, including any solid protective layers and topcoats, particularly layers of dissimilar composition, the adhesive material can bond equally well to said layers. The adhesives used can be polymers with functionalities having mutual affinity to the layers requiring bonding, the functionalities being specific to the chemical composition of the layers requiring bonding. In some embodiments, the bond strength can be high enough to promote cohesive failure between the individual layers.

In at least one embodiment, the adhesive layer can also include a coextruded structure of two or more layers, the outer layers of which will bond to the respective insulation layers or topcoats with which they are compatible.

In at least one embodiment, the adhesive layer between adjacent thermal insulation layers and between a thermal insulation layer and one or more of the other layers may, for example, include a grafted polymer or copolymer, or polymer blend with one or more moieties compatible with each of the individual layers to be bonded.

In at least one embodiment, the adhesive layer can be applied by powder spray application, or side-wrap, crosshead extrusion or co-extrusion methods.

In at least one embodiment, an additional adhesive layer may not be used, such as in cases where the two adjacent layers have a mutual affinity for each other, or where it is possible to achieve bonding of the layers using plasma or corona treatment.

### 3. Thermal Insulation Layer(s) and Protective Topcoat

The insulating layers (e.g., thermal insulation layer, e.g., layer 104, and pipe joint insulation, e.g., layer 106) used in the present disclosure can include a TPV composition and/or TPO composition described herein. The insulating layers can be designed to withstand operating temperatures in excess of the maximum operating temperatures (130° C. of systems currently used for the thermal insulation of subsea pipelines, such as polypropylene. These operating temperatures may be as high as 200° C. The thermal insulations can also be designed to exhibit adequate compressive creep resistance and modulus at these temperatures to prevent collapse of the foam structure in deep water installations, and hence maintain the required thermal insulation over the lifetime of the oil and gas recovery project. In addition, the compositions can be sufficiently ductile to withstand the bending strains experienced by the insulated pipe during reeling and installation operations.

In at least one embodiment, a thermal insulation layer and/or a pipe joint insulation comprises, consists essentially of, or consists of a TPV composition described herein, a TPO composition described herein, or a combination thereof.

In at least one embodiment, the insulating and/or protective coatings according to the present disclosure can be prepared from a high temperature resistant composition (e.g., a TPV composition and/or a TPO composition) that can be selected to provide solid or foam insulation layers with one or more of the following properties: (1) high compressive creep resistance at higher temperatures (such as about 7% or less triaxial creep), (2) high compressive modulus (such as 1000 MPa or more), (3) high compressive strength (such as about 25 MPa or more, uniaxial), (4) low thermal conductivity (such as less than about 0.2 W/m·K), (5) high specific heat capacity (such as greater than about 1300 J/kg·K), (6) high, long term temperature withstand capability (such as greater than about 100° C., such as greater than about 130° C., e.g., from about 130° C. to about 200° C. or from about 150° C. to about 200° C.), and/or (7) adequate ductility (such as greater than 10% elongation at break). In at least one embodiment, the insulating layers according to the present disclosure, having one or more of the above properties, can be applied at sufficient thicknesses so as to provide the insulated transport conduit with an acceptable heat transfer coefficient (U) for the conditions under which it is to be used, with U typically being in the range (in watts per squared meter kelvin (W/m²·K) from about 2 W/m²·K to about 10 W/m²·K. The thicknesses of the insulation layers can be highly variable, due to the fact that each pipeline system is designed for use under specific conditions of depth, temperature etc. In some embodiments, the insulating and protective coatings can have all the above properties.

In at least one embodiment, the thermal insulation layer comprises a composition, the composition comprising a thermoplastic olefin and a rubber, the composition having a high temperature resistant thermoplastic elastomer/thermoplastic vulcanizate having low thermal conductivity, high thermal softening point, high compressive strength, and/or high compressive creep resistance.

In at least one embodiment, one or more of the thermal insulation layers may also be provided with an additional protective layer, or topcoat, such as layer 105, comprising an unfoamed polymeric material. The protective layers can be prepared from the same material as the underlying thermal insulation layer, or a modified or reinforced version thereof.

In some embodiments, the outer protective topcoat can be made from a polymeric material having superior impact, abrasion, crush or chemical resistance to that from which the thermal insulation layer, or layers, is made. This can help impart a higher degree of physical or chemical performance, such as impact, abrasion, crush or moisture resistance, to the outer surface of the insulated pipe. Such a polymeric material may comprise the thermal insulation material blended with suitable polymeric modifiers, compatibilizers, or reinforcing fillers or fibers, or it may comprise a dissimilar, or compatible, polymeric material. In some embodiments, no adhesive layer is used between the final thermal insulation layer and topcoat to effect adequate bonding of the two layers. In some embodiments, an adhesive layer can be used between the final thermal insulation layer and topcoat to effect adequate bonding of the two layers.

In at least one embodiment, the insulation layers can include dissimilar materials, or materials foamed to different degrees. For example, a TPV composition (or TPO composition) with a higher temperature resistance and/or softening point can be used as an inner unfoamed or foamed thermal insulation layer closest to the hot steel pipe to function as a heat barrier, and a TPV composition (or TPO composition) having a lower temperature resistant and/or lower thermal conductivity unfoamed or foamed polymer as an outer secondary, or tertiary, thermal insulation layer.

In some embodiments, the thermal insulation layers can be foamed to different degrees the further they are away from the pipe wall; for example, outer layers of insulation may be foamed to progressively higher degrees than inner layers to provide tailored thermal performance of the system.

### 4. Foaming Agents

In some embodiments, foamed thermal insulation layers in the insulating and protective coatings according to the present disclosure can be prepared from the aforementioned high temperature resistant TPV compositions (and/or TPO compositions), by incorporating chemical foaming agents, by, for example, the physical injection of gas or volatile liquid, or by blending with hollow polymer, glass or ceramic microspheres. In some embodiments, however, glass and/or ceramic microspheres are not used in the thermal insulation layers.

Foams generated through the action of chemical or physical foaming agents are generally referred to as “blown” foams. Foams containing hollow microspheres are referred to as “syntactic” foams. Syntactic foams can provide superior compressive creep and crush resistance than blown foams, but are generally less efficient thermal insulators and are considerably more expensive. A cost and performance optimized design may, for example, comprise one or more layers of syntactic foam surrounded by one or more layers of blown foam insulation.

Chemical foaming agents may function via either an endothermic (heat absorbing) or exothermic (heat generating) reaction mechanism Chemical foaming agents can include sodium bicarbonate, citric acid, tartaric acid, azodicarbonamide, 4,4-oxybis(benzene sulphonyl) hydrazide, 5-phenyl tetrazole, dinitrosopentamethylene tetramine, p-toluene sulphonyl semicarbazide, and a combination thereof. In at least one embodiment, the chemical foaming agent can be an endothermic foaming agent, such as sodium bicarbonate blended with citric acid and/or tartaric acid.

Chemical foaming occurs when the foaming agent generates a gas, usually CO₂ or N₂, through decomposition when heated to a specific decomposition temperature. The initial decomposition temperature along with gas volume, release rate and solubility can be parameters when choosing a chemical foaming agent. For physical foaming, the gas or volatile liquid used can include CO₂, supercritical CO₂, N₂, air, helium, argon, aliphatic hydrocarbons, such as butanes, pentanes, hexanes and heptanes, chlorinated hydrocarbons, such as dichloromethane and trichloroethylene, and hydrochlorofluorocarbons, such as dichlorotrifluoroethane, and a combination thereof. In the case of volatile liquids, foaming occurs when the heated liquid vaporizes into gas. In at least one embodiment, the physical foaming agent can be supercritical CO₂.

In at least one embodiment, and if microspheres are used, the hollow microspheres can include glass, polymeric, or ceramic, including silica and alumina, microspheres. In at least one embodiment, the hollow microspheres can be lime-borosilicate glass microspheres.

### 5. Thermal Insulation Application Process

The thermal insulation layer(s) that include a TPV composition (and/or TPO composition) described herein and/or other layer(s) that include a TPV composition (and/or TPO composition) described herein can be applied as any layer outside of the pipe. For example, it can be applied as the layer touching the steel pipe or the layer furthest from the steel pipe.

In at least one embodiment, the foamed or unfoamed thermal insulation layer, or layers, and any unfoamed protective layers, can be applied to the steel pipe or a pipeline, such as over the corrosion protection coating, or coatings, by, e.g., a sidewrap extrusion process, crosshead extrusion process, or co-extrusion process.

In at least one embodiment, extrusion can be accomplished using single screw extrusion, either in single or tandem configuration, or by twin-screw extrusion methods. In the case of single screw extrusion, the extruder screw may be either single stage or 2-stage design.

In at least one embodiment, the a single stage compression screw can be adequate for chemical foam extrusion whereby the foaming agent can be added as a pelleted concentrate or masterbatch which is pre-mixed with the polymer to be foamed using a multi-component blender, for example, mounted over the main feed port of the extruder. The design of the screw can incorporate barrier flights and mixing elements to ensure effective melting, mixing, and conveying of the polymer and foaming agent.

With a 2-stage screw, and according to at least one embodiment, the first and second stages can be separated by a decompression zone, at which point a gas or liquid physical foaming agent can be introduced into the polymer melt via an injection or feed port in the extruder barrel. The first stage can act to melt and homogenize the polymer, and the second stage can act to disperse the foaming agent, cool the melt temperature, and increase the melt pressure prior to the melt exiting the die. This may also be accomplished by tandem extrusion, wherein the two stages are effectively individual single screw extruders, the first feeding into the second. A 2-stage screw can be used for the extrusion of polymers which have a tendency to release volatiles when melted, or are hygroscopic, the extruder barrel then being equipped with a vent port positioned over the decompression zone through which the volatiles or moisture can be safely extracted.

Twin screw extrusion can be used, for example, when the polymer to be foamed is shear sensitive, when the fillers other additives be incorporated into the insulation composition, or when extruding syntactic foams or blown foams prepared by the physical injection of a gas or liquid foaming agent. Since the twin screw design is typically modular, comprising several separate and interchangeable screw elements, such as mixing and conveying elements, it can offer great versatility with respect to tailoring the screw profile for optimum mixing and melt processing.

In some embodiments, and for syntactic foams, for example, the hollow microspheres can be fed directly into the polymer melt using a secondary twin-screw feeder downstream of the main polymer feed hopper. An additional consideration with syntactic foams is potential breakage of the hollow microspheres during extrusion of the foam. Shear and compressive forces inside the extruder can be minimized during processing of the foam to prevent this through judicious design of the extruder screw(s), barrels, manifolds and dies. Alternately, and in some embodiments, no microspheres are used in the compositions.

In at least one embodiment, the static mixing attachment or gear pump can be inserted between the end of the screw and the die to further homogenize the melt, generate melt pressure, and minimize melt flow fluctuations.

In some embodiments, for chemically or physically blown foams, the degree of foaming can be dependent upon the balance of thermal conductivity and compressive strength. Too high a degree of foaming may be detrimental to the compressive strength and creep resistance of the foam. In some embodiments, the TPV compositions (and/or TPO compositions) described herein can be foamed from about 5% to about 50%, such as from about 5% to about 30%, or about 10% to about 25%. The degree of foaming can be defined herein as the degree of rarefaction, i.e. the decrease in density, and can be defined as [(Dₘₐₜᵣᵢₓ−D_{foam})/Dₘₐₜᵣᵢₓ]×100. Expressed in this way, the degree of foaming reflects the volume percentage of gas under the assumption that the molecular weight of gas is negligible compared to that of the matrix, which is generally true. Alternatively, the degree of foaming can be measured visually by microscopic determination of cell density.

In some embodiments, with respect to the particular foam insulations described herein, the conditions of mixing, temperature and pressure can be adjusted to provide a uniform foam structure comprising very small or microcellular bubbles with a narrow size distribution evenly distributed within the polymer matrix, in order to ensure maximum compressive strength, thermal performance and compressive creep resistance of the insulation when subjected to high external pressures and pressures. Also, when extruding blown foam insulation the foaming can be prevented until the polymer exits the extrusion die.

In at least one embodiment, the actual coating of the pipe may be accomplished using an annular crosshead die attached to the thermal insulation extruder through which the pre-heated pipe, with a prior-applied corrosion protection layer or multi-layer corrosion protection system, is conveyed, the thermal insulation thereby covering the entire surface of the pipe by virtue of the annular die forming said thermal insulation into a tubular profile around the conveyed pipe.

Alternatively, and in some embodiments, the thermal insulation may be applied by a side-wrap technique whereby the thermal insulation can be extruded through a flat strip or sheet die. The thermal insulation can be extruded in the form of a sheet or tape which can then be wrapped around the pipe. In some embodiments, one can apply a number of wraps to achieve the required thermal insulation thickness and, hence, performance. The individually wrapped layers can be fused together by virtue of the molten state of the material being extruded. In some embodiments, one can preheat the outer surface of the previous layer to ensure proper adhesion of any subsequent layer.

In some embodiments, the application of thermal insulation by the side-wrap technique may involve wrapping the pipe as it is simultaneously rotated and conveyed forwardly along its longitudinal axis. It may also involve the application of a pre-extruded tape using rotating heads while the pipe is conveyed longitudinally but not rotated. In this particular case, the winding angle of the thermal insulation layers can be adjusted by varying the speed of pipe movement in the longitudinal direction and/or by varying the rotational speed of the pipe or the rotating heads. The tape may be wound in successive layers at opposite winding angles to maintain neutrality of the pipe, until the required thickness has been built up. Furthermore, it may be desired that the applied layers of thermal insulation do not become joined and that they are able to slide over each other with little resistance in order to avoid increasing bend stiffness or bend dynamics.

In some embodiments where an adhesive layer is applied between the corrosion protection layer, or system, and the thermal insulation layer, or between individual thermal insulation layers, this can be accomplished using either a single layer sheet or annular die, or a co-extrusion die whereby a multi-layer adhesive or the adhesive and thermal insulation layers are applied simultaneously. In some embodiments, the outer protective topcoat may be similarly applied.

### 6. Pipe Joint Insulation System

The pipe joint insulation system referred to in FIG. 2 can include a high temperature resistant TPV (and/or TPO) insulation layer 106, identical or similar in composition to the TPV (and/or TPO) of thermal insulation layer, or layers, and which is bondable to the corrosion protection layer or system 107, the existing thermal insulation layer(s) 104, and the topcoat 105.

In at least one embodiment, the pipe joint insulation system can also include a corrosion protection layer 107 which may have a single or multi-layer structure. In at least one embodiment, the corrosion protection layer is similar or identical to the corrosion protection layers and systems described above in connection with FIG. 1. For example, the corrosion protection layer 107 may comprise an epoxy layer and/or adhesive layer previously described, applied directly to the welded joint area of the steel pipe prior to the application of thermal insulation layer, or layers.

In at least one embodiment, the pipe joint insulation can be applied by direct extrusion injection into a mold designed to conform to the outer dimensions of the insulated pipe. The processing conditions can be similar to those used to apply the thermal insulation layer, or layers, of similar or identical composition.

In at least one embodiment, the pipe joint insulation composition may be applied either foamed or as an unfoamed solid.

### Formulations of the TPV Compositions and the TPO Compositions

In at least one embodiment, the TPV composition (and/or TPO composition) can include an amount of a rubber such that is about 80 wt % or less, such as about 70 wt % or less, such as about 50 wt % or less, such as about 40 wt % or less, such as about 30 wt % or less, such as about 25 wt % or less, such as about 20 wt % or less, such as about 15 wt % or less, such as about 10 wt % or less, such as about 5 wt %, based on a combined weight of the rubber and the thermoplastic polyolefin. In these or other embodiments, the amount of rubber within the TPV composition (and/or TPO composition) can be from about 5 wt % to about 80 wt %, such as from about 10 wt % to about 60 wt %, such as from about 15 wt % to about 55 wt %, such as from about 20 wt % to about 50 wt %, such as from about 25 wt % to about 45 wt %, such as from about 30 wt % to about 40 wt %, based on a combined weight of the rubber and the thermoplastic polyolefin. In at least one embodiment, the TPV composition (and/or TPO composition) can include one or more types of rubber.

In at least one embodiment, the TPV composition (and/or TPO composition) can include an amount of a thermoplastic phase (e.g., a thermoplastic polymer or a thermoplastic polyolefin) that is about 20 wt % or more, such as about 30 wt % or more, such as about 50 wt % or more, such as about 60 wt % or more, such as about 70 wt % or more, such as about 75 wt % or more, such as about 80 wt % or more, such as about 85 wt % or more, such as about 90 wt % or more, such as about 95 wt %, based on a combined weight of the rubber and the thermoplastic phase. In these or other embodiments, the amount of thermoplastic phase within the TPV composition (and/or TPO composition) can be from about 20 wt % to about 95 wt %, such as from about 40 wt % to about 90 wt %, such as from about 45 wt % to about 85 wt %, such as from about 50 wt % to about 80 wt %, such as from about 55 wt % to about 75 wt %, such as from about 60 wt % to about 70 wt %, based on a combined weight of the rubber and the thermoplastic phase. In at least one embodiment, the TPV composition (and/or TPO composition) can include one or more types of thermoplastic phase.

In at least one embodiment, and where the thermoplastic phase may include a blend of propylene-based polymer and ethylene-based polymer, the thermoplastic phase may include from about 51 wt % to about 100 wt % of propylene-based polymer (such as from about 65 wt % to about 99.5 wt %, such as from about 85 wt % to about 99 wt %, such as from about 95 wt % to about 98 wt %) based on a total weight of the thermoplastic phase, with balance of the thermoplastic phase including an ethylene-based polymer. For example, in some embodiments, the thermoplastic phase may include from about 0 wt % to about 49 wt % of ethylene-based polymer (such as from about 1 wt % to about 15 wt %, such as from about 2 wt % to about 5 wt %) based on the total weight of the thermoplastic phase.

In at least one embodiment, fillers (such as calcium carbonate, clays, silica, talc, titanium dioxide, carbon black, a nucleating agent, mica, wood flour, and the like, and blends thereof, as well as inorganic and organic nanoscopic fillers) may be present in the TPV composition (and/or TPO composition) in an amount from about 0.1 wt % to about 10 wt % based on the total weight of the TPV composition (and/or TPO composition), such as from about 1 wt % to about 7 wt %, such as from about 2 wt % to about 5 wt %. The amount of filler that can be used may depend, at least in part, upon the type of filler and the amount of extender oil that is used.

In at least one embodiment, an oil (e.g., an extender oil) may be present in the TPV composition (and/or TPO composition) in an amount from about 10 wt % to about 40 wt % by weight of combined TPV composition (and/or TPO composition), such as from about 12 wt % to about 35 wt %, such as from about 14 wt % to about 32 wt %. The quantity of oil added can depend on the properties desired, with an upper limit that may depend on the compatibility of the particular oil and blend ingredients; and this limit can be exceeded when excessive exuding of oil occurs. The amount of oil can depend, at least in part, upon the type of rubber. High viscosity rubbers are more highly oil extendable. Where low molecular weight ester plasticizers are employed, the ester plasticizers are generally used in amounts of about 40 wt % or less, such as about 35 wt % or less based on total TPV composition (and/or TPO composition).

In at least one embodiment, the TPV composition (and/or TPO composition) can include a curative. Amounts and types of curatives that are useful for the TPV compositions (and/or TPO composition) described herein are discussed below.

In at least one embodiment, and when employed, the TPV composition (and/or TPO composition) may include a processing additive (e.g., a polymeric processing additive) in an amount of from about 0.1 wt % to about 20 wt % based on the total weight of the TPV composition (and/or TPO composition).

In at least one embodiment, the TPV composition (and/or TPO composition) may optionally include reinforcing and non-reinforcing fillers, colorants, antioxidants, nucleators, stabilizers, rubber processing oil, lubricants, antiblocking agents, anti-static agents, waxes, foaming agents, pigments, flame retardants, antistatic agents, slip masterbatches, siloxane based slip agents (e.g., Dow Corning™ HMB-0221 Masterbatch available from Dow Chemical Company) ultraviolet inhibitors, antioxidants, and other processing aids known in the rubber and TPV (or TPO) compounding art. These additives can be used in the TPV compositions (and/or TPO compositions) at an amount up to about 20 wt % of the total weight of the TPV composition (and/or TPO composition).

In at least one embodiment, a TPV composition (or TPO composition) for insulating fluid and/or gas transport conduits, such as off-shore oil and gas pipelines operating at temperatures of about 100° C. or higher in water depths above about 1,000 meters. In some embodiments, the TPV composition (or TPO composition) can be formed from an extremely low thermal conductivity rubber component and a high temperature resistant thermoplastic component having low thermal conductivity, high thermal softening point, high compressive strength, and/or high compressive creep resistance. In some embodiments, the rubber can be non-crosslinked, crosslinked, or partially crosslinked. In some embodiments, the outer surface of the conduit is provided with at least one layer of solid insulation comprising a high temperature resistant TPV (and/or TPO) composition having low thermal conductivity, high thermal softening point, high compressive strength, and high compressive creep resistance. In some embodiments, the thermoplastic phase of the TPV (and/or TPO) composition can include polypropylene, polyphenylene oxide blended with polypropylene, polybutylene terephthalate, polyethylene terephthalate, acrylonitrile butadiene styrene, acrylonitrile styrene acrylate, polyetherimide, polyamides (including polyamide 12 and 6), polymethylpentene (and blends thereof), cyclic olefin copolymers, and a combination thereof.

### Rubber Phase

In at least one embodiment, the rubber phase can be non-crosslinked, crosslinked, or partially crosslinked. Reference to a rubber may include mixtures of more than one rubber. Rubbers that may be employed to form the rubber phase include those polymers that are capable of being cured or crosslinked by a phenolic resin or a hydrosilylation curative (e.g., silane-containing curative), a peroxide with a coagent, a moisture cure via silane grafting, or an azide.

Non-limiting examples of rubbers can include olefinic elastomeric terpolymers, nitrile rubbers, butyl rubbers (such as isobutylene-isoprene rubber (IIR), brominated isobutylene-isoprene rubber (BIIR), and isobutylene paramethyl styrene rubber (BIMSM), polyisobutylene rubber (PIB)), natural rubbers, ethylene propylene rubbers (EPR), acrylic rubbers such as alkyl acrylate copolymers (ACM), styrenic-block copolymers (SBC), styrene-butadiene-styrene (SBS) polymers, hydrogenated styrenic copolymers such as SEBS, SEEPS, fluoroelastomer rubbers (e.g., FKM), and mixtures thereof. In at least one embodiment, the olefinic elastomeric terpolymers can include ethylene-based elastomers such as ethylene-propylene-non-conjugated diene rubbers. In some embodiments, the polyisobutylene rubber can be liquid, solid bale, or masterbatch pellet form, can be oligomeric, polymeric, or a combination thereof. Non-limiting examples of rubber phases include ethylene based plastomer/elastomers such as Engage™ and Exact™, as well as propylene based plastomers/elastomers such as Vistamaxx™ (including Vistamaxx™ 6102) and Versify™

### 1. Ethylene-Propylene Rubber

The term ethylene-propylene rubber refers to rubbery terpolymers polymerized from ethylene, at least one other α-olefin monomer, and at least one diene monomer (for example. an ethylene-propylene-diene terpolymer or an EPDM terpolymer). In at least one embodiment, the α-olefin monomer(s) may include propylene, 1-butene, 1-hexene, 4-methyl-1-pentene, 1-octene, 1-decene, or combinations thereof. In at least one embodiment, the α-olefins can include propylene, 1-hexene, 1-octene or combinations thereof. In at least one embodiment, the diene monomers may include 5-ethylidene-2-norbornene; 5-vinyl-2-norbornene; divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. Polymers prepared from ethylene, α-olefin, and diene monomers may be referred to as a terpolymer or even a tetrapolymer in the event that multiple α-olefins or dienes are used.

In some embodiments, and where the diene includes 5-ethylidene-2-norbornene (ENB) and/or 5-vinyl-2-norbornene (VNB), the ethylene-propylene rubber may include at least about 1 wt %, such as at least about 3 wt %, such as at least about 4 wt %, such as at least about 5 wt %, based on the total weight of the ethylene-propylene rubber. In at least one embodiment, and where the diene includes ENB and/or VNB, the ethylene-propylene rubber may include from about 1 wt % to about 15 wt % (such as from about 3 wt % to about 15 wt %, such as from about 5 wt % to about 12 wt %, such as from about 7 wt % to about 11 wt %) from 5-ethylidene-2-norbornene based on the total weight of the ethylene-propylene rubber.

In some embodiments, the ethylene-propylene rubber can include one or more of the following characteristics:

1) An ethylene-derived content that can be from about 10 wt % to about 99.9 wt %, such as from about 10 wt % to about 90 wt %, such as from about 12 wt % to about 90 wt %, such as from about 15 wt % to about 90 wt %, such as from about 20 wt % to about 80 wt %, such as from about 40 wt % to about 70 wt %, such as from about 45 wt % to about 65 wt %, based on the total weight of the ethylene-propylene rubber. In some embodiments, the ethylene-derived content can be from about 40 wt % to about 85 wt %, such as from about 40 wt % to about 85 wt % based on the total weight of the ethylene-propylene rubber.

2) A diene-derived content that can be from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt %, based on the total weight of the ethylene-propylene rubber. In some embodiments, the diene-derived content can be from about 3 wt % to about 15 wt % based on the total weight of the ethylene-propylene rubber.

3) The balance of the ethylene-propylene rubber can include α-olefin-derived content (e.g., C2 to C40, such as C3 to C20, such as C3 to C10 olefins, such as propylene).

4) A weight average molecular weight (Mw) that can be about 100,000 g/mol or more, such as about 200,000 g/mol or more, such as about 400,000 g/mol or more, such as about 600,000 g/mol or more. In these or other embodiments, the Mw can be about 1,200,000 g/mol or less, such as about 1,000,000 g/mol or less, such as about 900,000 g/mol or less, such as about 800,000 g/mol or less. In these or other embodiments, the Mw can be from about 400,000 g/mol to about 3,000,000 g/mol, such as from about 400,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol.

5) A number average molecular weight (Mn) that can be about 20,000 g/mol or more, such as about 60,000 g/mol or more, such as about 100,000 g/mol or more, such as about 150,000 g/mol or more. In these or other embodiments, the Mn can be about 500,000 g/mol or less, such as about 400,000 g/mol or less, such as about 300,000 g/mol or less, such as about 250,000 g/mol or less.

6) A Z-average molecular weight (Mz) that can be from about 10,000 g/mol to about 7,000,000 g/mol, such as from about 50,000 g/mol to about 3,000,000 g/mol, such as from about 70,000 g/mol to about 2,000,000 g/mol, such as from about 75,000 g/mol to about 1,500,000 g/mol, such as from about 80,000 g/mol to about 700,000 g/mol, such as from about 100,000 g/mol to about 500,000 g/mol.

7) A polydispersity index (Mw/Mn; PDI) that can be from about 1 to about 10, such as from about 1 to about 5, such as from about 1 to about 4, such as from about 2 to about 4 or from about 1 to about 3, such as from about 1.8 to about 3 or from about 1 to about 2, or from about 1 to about 2.5.

8) A dry Mooney viscosity (ML(1+4) at 125° C.) per ASTM D-1646, that can be from about 10 MU to about 500 MU or from about 50 MU to about 450 MU. In these or other embodiments, the Mooney viscosity is 250 MU or more, such as 350 MU or more.

9) A glass transition temperature (Tg), as determined by Differential Scanning calorimetry (DSC) according to ASTM E1356, that can be about −20° C. or less, such as about −30° C. or less, such as about −50° C. or less. In some embodiments, the Tg can be from about −20° C. to about −60° C.

The ethylene-propylene rubber may be manufactured or synthesized by using a variety of techniques. For example, these terpolymers can be synthesized by employing solution, slurry, or gas phase polymerization techniques or a combination thereof that employ various catalyst systems including Ziegler-Natta systems including vanadium catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed. Optionally, such EPDMs can be prepared using the above catalyst systems in a solution process.

Some elastomeric terpolymers are commercially available under the tradenames Vistalon™ (ExxonMobil Chemical Co.; Houston, Tex.), Keltan™ (Arlanxeo Performance Elastomers; Orange, Tex.), Nordel™ IP (Dow), NORDEL MG™ (Dow), Royalene™ (Lion Elastomers), KEP (Kumho Polychem), and Suprene™ (SK Global Chemical). Specific examples include Vistalon 3666, Vistalon 9600, Keltan 9950C, Keltan 8550C, KEP 8512, KEP 9590, Keltan 5469 Q, Keltan 4969 Q, Keltan 5469 C, and Keltan 4869 C, Royalene 694, Royalene 677, Suprene 512F, Nordel 6555, Nordel 4571XFM, Royalene 515.

In some embodiments, the ethylene propylene rubber may be obtained in an oil extended form, with about a 50 phr to about 200 phr process oil, such as about 75 phr to about 120 phr process oil on the basis of 100 phr of elastomer.

### 2. Nitrile Rubber

Suitable nitrile rubbers comprise rubbery polymers of 1,3-butadiene or isoprene and acrylonitrile. Exemplary nitrile rubbers include polymers of 1,3-butadiene and about 20-50 weight percent acrylonitrile.

In some embodiments, the nitrile rubber can include one or more of the following characteristics:

1) An acrylonitrile-derived content that can be about 20 wt % or more, such as from about 20 wt % to about 50 wt %, 25 wt % to about 45 wt %, such as from 30 wt % to about 40 wt %, such as from about 35 wt % to about 40 wt %, based on the total weight of the nitrile rubber.

2) Where the nitrile rubber is a copolymer of isoprene and acrylonitrile, an isoprene-derived content that can be from about 10 wt % to about 99.9 wt %, such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, based on the total weight of the ethylene-propylene rubber. In some embodiments, the ethylene-derived content can be from about 40 wt % to about 85 wt %, such as from about 40 wt % to about 85 wt %, based on the total weight of the composition.

3) Where the nitrile rubber is a copolymer of 1,3-butadiene and acrylonitrile, a 1,3-butadiene-derived content that can be from about 10 wt % to about 99.9 wt %, such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, based on the total weight of the ethylene-propylene rubber. In some embodiments, the ethylene-derived content is from about 40 wt % to about 85 wt %, such as from about 40 wt % to about 85 wt %, based on the total weight of the composition.

4) A weight average molecular weight (Mw) that can be about 100,000 g/mol or more, such as about 200,000 g/mol or more, such as about 400,000 g/mol or more, such as about 600,000 g/mol or more. In these or other embodiments, the Mw can be about 1,200,000 g/mol or less, such as about 1,000,000 g/mol or less, such as about 900,000 g/mol or less, such as about 800,000 g/mol or less. In these or other embodiments, the Mw can be from about 500,000 g/mol to about 3,000,000 g/mol, such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol.

Nitrile rubber can be obtained from a number of commercial sources as disclosed in the Rubber World Blue Book.

A functionalized nitrile rubber containing one or more graft forming functional groups may be used for preparing block copolymers of the present disclosure. The aforesaid “graft forming functional groups” are different from and are in addition to the olefinic and cyano groups normally present in nitrile rubber. Carboxylic-modified nitrile rubbers containing carboxy groups and amine-modified nitrile rubbers containing amino groups are also useful for the TPV (and/or TPO) compositions described herein.

### 3. Butyl Rubber

In some embodiments, butyl rubber can include copolymers and terpolymers of isobutylene and at least one other comonomer. Useful comonomers can include isoprene, divinyl aromatic monomers, alkyl substituted vinyl aromatic monomers, and mixtures thereof. Exemplary divinyl aromatic monomers include vinylstyrene. Exemplary alkyl substituted vinyl aromatic monomers can include α-methylstyrene and paramethylstyrene. These copolymers and terpolymers may also be halogenated butyl rubbers (also known as halobutyl rubbers) such as in the case of chlorinated butyl rubber and brominated butyl rubber. In some embodiments, these halogenated polymers may derive from monomer such as parabromomethylstyrene.

In some embodiments, butyl rubber can include copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers may be halogenated. Exemplary butyl rubbers can include isobutylene-isoprene rubber (IIR), brominated isobutylene-isoprene rubber (BIIR), chlorinated isobutylene-isoprene rubber (CIIR), and isobutylene paramethyl styrene rubber (BIMSM).

In some embodiments, the butyl rubber can includes one or more of the following characteristics:

1) Where butyl rubber includes the isobutylene-isoprene rubber, the rubber may include isoprene from about 0.5 wt % to about 30 wt %, such as from about 0.8 wt % to about 5 wt %, based on the entire weight of the rubber with the remainder being isobutylene.

2) Where butyl rubber includes isobutylene-paramethylstyrene rubber, the rubber may include paramethylstyrene from about 0.5 wt % to about 25 wt %, such as from about 2 wt % to about 20 wt %, such as from about 7 wt % to 12 wt %, based on the entire weight of the rubber with the remainder being isobutylene.

3) Where the isobutylene-paramethylstyrene rubbers are halogenated, such as with bromine, these halogenated rubbers can contain a percent by weight halogenation of from about 0 wt % to about 10 wt %, such as from about 0.3 wt % to about 7 wt %, such as about 0.5 wt % to about 3.0 wt % based on the entire weight of the rubber with the remainder being isobutylene.

4) Where the isobutylene-isoprene rubbers are halogenated, such as with bromine, these halogenated rubbers can contain a percent by weight halogenation of from about 0 wt % to about 10 wt %, such as from about 0.3 wt % to about 7 wt %, based on the entire weight of the rubber with the remainder being isobutylene.

5) Where butyl rubber includes isobutylene-isoprene-divinylbenzene, the rubber may include isobutylene from about 95 wt % to about 99 wt %, such as from about 96 wt % to about 98.5 wt %) based on the entire weight of the rubber, and isoprene from about 0.5 wt % to about 5 wt % (such as from about 0.8 wt % to about 2.5 wt %, based on the entire weight of the rubber, with the balance being divinylbenzene.

6) Where the butyl rubber includes halogenated butyl rubbers, the butyl rubber may include from about 0.1 wt % to about 10 wt % halogen, such as from about 0.3 wt % to about 7 wt %, such as from about 0.5 wt % to about 3 wt %, based upon the entire weight of the rubber.

7) A glass transition temperature (Tg) that can be about −55° C. or less, such as about −58° C. or less, such as about −60° C. or less, such as about −63° C. or less.

8) A weight average molecular weight (Mw) that can be about 100,000 g/mol or more, such as about 200,000 g/mol or more, such as about 400,000 g/mol or more, such as about 600,000 g/mol or more. In these or other embodiments, the Mw can be about 1,200,000 g/mol or less, such as about 1,000,000 g/mol or less, such as about 900,000 g/mol or less, such as about 800,000 g/mol or less. In these or other embodiments, the Mw can be from about 500,000 g/mol to about 3,000,000 g/mol, such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol.

Butyl rubber can be obtained from a number of commercial sources as disclosed in the Rubber World Blue Book. For example, both halogenated and un-halogenated rubbers/copolymers of isobutylene and isoprene are available under the tradename Exxon Butyl™ (ExxonMobil Chemical Co.), halogenated and un-halogenated copolymers of isobutylene and paramethylstyrene are available under the tradename EXXPRO™, including but not limited to EXXPRO 3563 (ExxonMobil Chemical Co.), star branched butyl rubbers are available under the tradename STAR BRANCHED BUTYL™ (ExxonMobil Chemical Co.), and copolymers containing parabromomethylstyrenyl mer units are available under the tradename EXXPRO 3745 (ExxonMobil Chemical Co.). Halogenated and non-halogenated terpolymers of isobutylene, isoprene, and divinylstyrene are available under the tradename Polysar Butyl™ (Lanxess; Germany).

### 4. Styrenic-Based Rubbers

In some embodiments, the styrenic-based rubber is a styrenic-block copolymer (SBC), styrene-butadiene-styrene copolymers (SBS), hydrogenated styrenic copolymer such as styrene-ethylene-butylene-styrene copolymers (SEBS), Styrene-ethylene-ethylene-propylene-styrene copolymers (SEEPS), and mixtures thereof.

In some embodiments, the SBS copolymer can comprise or consist essentially of a styrene-mono(lower)olefin-styrene, or, styrene-isoprene-styrene, or a styrene-butadiene-styrene block copolymer having a hardness in the range from Shore A 30 up to Shore 90.

Table A shows non-limiting examples of rubber phases along with their thermal conductivities. Selection of the rubber phase for the TPV (and/or TPO) composition can be based on the thermal conductivity of the rubber phase.

TABLE A

| Rubber Phase | Thermal Conductivity (W/m · K) |
|---|---|
| Butyl rubber (e.g., IIR, | 0.10 |
| BIIR, BIMSM, PIB) | |
| Natural rubber | 0.14 |
| Silicone rubber | 0.14 |
| Nitrile Rubber | 0.24 |
| FKM | 0.19 |

In some embodiments, the rubber can be highly cured. In some embodiments, the rubber can be advantageously partially or fully (completely) cured. In some embodiments, the rubber can be advantageously not cured or crosslinked. The degree of cure can be measured by determining the amount of rubber that is extractable from the TPV (and/or TPO) composition by using cyclohexane or boiling xylene as an extractant. This method is disclosed in U.S. Pat. No. 4,311,628, which is incorporated herein by reference for purposes of U.S. patent practice. In some embodiments, the rubber can have a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for purpose of U.S. patent practice. In these or other embodiments, the rubber can be cured to an extent where greater than about 94 wt %, such as greater than about 95 wt %, such as greater than about 96 wt %, such as greater than about 97 wt % by weight of the rubber is insoluble in cyclohexane at 23° C. Alternately, in some embodiments, the rubber can have a degree of cure such that the crosslink density is at least 4×10⁻⁵ moles per milliliter of rubber, such as at least 7×10⁻⁵ moles per milliliter of rubber, such as at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

In some embodiments, the TPV or TPO may comprise an isobutylene-paramethylstyrene rubber having a paramethylstyrene derived content from about 0.5 wt % to about 25 wt %, such as from about 2 wt % to about 20 wt %, such as about 7 wt % to about 12 wt %, based on the entire weight of the rubber with the remainder being isobutylene. When used in TPV formulations, the resulting TPV may have a hardness from 40 shore A to 40 Shore D, such as 50 shore A to 30 shore D. Such TPVs may utilize various fillers such as clay or talc at loadings from 5 phr to 40 phr. Various thermoplastic polymers may be utilized for the thermoplastic phase including polypropylenes, such as a polypropylene having a MFR of 0.8 g/10 min to 1800/10 min at 230 C. Various plasticizers or oils may be used in such formulations including hydrocarbon resins, polyisobutylene or paraffinic oils. Curing systems useful for making such TPVs are disclosed in greater detail herein.

Despite the fact that the rubber may be partially or fully cured, the compositions of this disclosure can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In some embodiments, a co-continuous morphology or a phase inversion can be achieved. In those embodiments where the cured rubber is in the form of finely-divided and well-dispersed particles within the thermoplastic medium, the rubber particles can have an average diameter that is about 50 μm or less, such as about 30 μm or less, such as about 10 μm or less, such as about 5 μm or less, such as about 1 μm or less. In some embodiments, at least about 50%, such as about 60%, such as about 75% of the particles can have an average diameter of about 5 μm or less, such as about 2 μm or less, such as about 1 μm or less.

### Thermoplastic Phase

In some embodiments, the thermoplastic phase of the TPV (and/or TPO) composition can include a polymer with a high temperature Vicat softening point, such as from about 100° C. to about 200° C., such as from about 130° C. to about 180° C., and/or a thermal conductivity of about 0.2 W/m·K or less, such as from about 0.10 W/m·K to about 0.20 W/m·K, such as from about 0.15 W/m·K to about 0.18 W/m·K. In some embodiments, the thermoplastic phase of the TPV (and/or TPO) compositions include a polymer that can flow above its melting temperature.

In some embodiments, the thermoplastic phase (e.g., a thermoplastic polymer or a thermoplastic polyolefin) can include more than one thermoplastic polymers. Non-limiting examples of thermoplastic polymers can include polypropylene (e.g., homopolymer, random copolymer, ICP), polyethylene (homopolymer, random copolymer), syndiotactic polystyrene, cyclic olefin copolymer, polyphenylene oxide (PPO) blended with polypropylene, polybutylene terephthalate, polyethylene terephthalate, acrylonitrile butadiene styrene, acrylonitrile styrene acrylate, polyetherimide, polyamide, polymethylpentene polymethylpentene resin (such as a homopolymer or copolymer, e.g., a homopolymer or copolymer of 4-methyl-1-pentene), or a combination thereof.

In at least one embodiment the thermoplastic phase can include polyphenylene oxide blended with homopolymers or copolymers of polypropylene, polystyrene, and/or polyamide. In these and other embodiments, this blend can be predominantly polyphenylene oxide, e.g., polyphenylene oxide is present in the blend in an amount of at least about 50 wt %. Examples of polyphenylene oxide-polypropylene blends useful for the TPV compositions (and/or TPO compositions) are commercially available under the trade name Noryl™, such as Noryl™ GTX

In some embodiments, the major component of the thermoplastic phase can include at least one thermoplastic polyolefin such as a polypropylene (such as a homopolymer, random copolymer, or impact copolymer, or combination thereof), an ethylene-based polymer (e.g., a polyethylene), a butene-based polymer (e.g., a polybutene), or a combination thereof. In some embodiments, the thermoplastic phase may also include, as a minor constituent, at least one thermoplastic polyolefin such as an ethylene-based polymer (e.g., polyethylene), a propylene-based polymer (e.g., polypropylene), or a butene-based polymer (e.g., a polybutene or a polybutene-1).

### 1. Propylene-Based Polymer

Propylene-based polymers can include those solid, generally high-molecular weight plastic resins that primarily comprise units deriving from the polymerization of propylene. In some embodiments, least 75%, or at least 90%, or at least 95%, or at least 97% of the units of the propylene-based polymer can derive from the polymerization of propylene. In particular embodiments, these polymers can include homopolymers of propylene. Homopolymer polypropylene can include linear chains and/or chains with long chain branching.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. In at least one embodiment can be included the reactor, impact, and random copolymers of propylene with ethylene or the higher α-olefins, described above, or with C10-C20 olefins.

In some embodiments, the propylene-based polymer can include one or more of the following characteristics:

1) The propylene-based polymers may include semi-crystalline polymers. In some embodiments, these polymers may be characterized by a crystallinity of at least about 25 wt % or more, such as about 55 wt % or more, such as about 65 wt % or more, such as about 70 wt % or more. Crystallinity may be determined by dividing the heat of fusion (Hf) of a sample by the heat of fusion of a 100% crystalline polymer, which is assumed to be 209 joules/gram for polypropylene.
2) A Hf that can be about 52.3 J/g or more, such as about 100 J/g or more, such as about 125 J/g or more, such as about 140 J/g or more.
3) A weight average molecular weight (Mw) that can be from about 50,000 g/mol to about 2,000,000 g/mol, such as from about 100,000 g/mol to about 1,000,000 g/mol, such as from about 100,000 g/mol to about 600,000 g/mol or from about 400,000 g/mol to about 800,000 g/mol, as measured by GPC with polystyrene standards.
4) A number average molecular weight (Mn) that can be from about 25,000 g/mol to about 1,000,000 g/mol, such as from about 50,000 g/mol to about 300,000 g/mol as measured by GPC with polystyrene standards.
5) A g′vis that can be 1 or less, such as 0.9 or less, such as 0.8 or less, such as 0.6 or less, such as 0.5 or less.
6) A melt mass flow rate (MFR) (ASTM D1238, 2.16 kg weight @ 230° C.) that can be about 0.1 g/10 min or more, such as about 0.2 g/10 min or more, such as about 0.2 g/10 min or more. Alternately, the MFR can be from about 0.1 g/10 min to about 50 g/10 min, such as from about 0.5 g/10 min to about 5 g/10 min, such as from about 0.5 g/10 min to about 3 g/10 min.
7) A melt temperature (Tm) that can be from about 110° C. to about 170° C., such as from about 140° C. to about 168° C., such as from about 160° C. to about 165° C.
8) A glass transition temperature (Tg) that can be from about −50° C. to about 10° C., such as from about −30° C. to about 5° C., such as from about −20° C. to about 2° C.
9) A crystallization temperature (Tc) that can be about 75° C. or more, such as about 95° C. or more, such as about 100° C. or more, such as about 105° C. or more, such as from about 105° C. to about 130° C.

In some embodiments, the propylene-based polymers can include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins may be characterized by a MFR (ASTM D-1238; 2.16 kg @ 230° C.) that is about 10 dg/min or less, such as about 1.0 dg/min or less, such as about 0.5 dg/min or less.

In some embodiments, the polypropylene can include a homopolymer, random copolymer, or impact copolymer polypropylene or combination thereof. In some embodiments, the polypropylene can be a high melt strength (HMS) long chain branched (LCB) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions (and/or TPO compositions) described herein can include ExxonMobil™ PP5341 (available from ExxonMobil); Achieve™ PP6282NE1 (available from ExxonMobil) and/or polypropylene resins with broad molecular weight distribution as described in U.S. Pat. Nos. 9,453,093 and 9,464,178; and other polypropylene resins described in US20180016414 and US20180051160 (for example, EXP-PP, as shown in the Table below); Waymax MFX6 (available from Japan Polypropylene Corp.); Borealis Daploy™ WB140 (available from Borealis AG); and Braskem Ampleo 1025MA, Braskem Ampleo 1020GA, Braskem F008F, Braskem F180A (available from Braskem Ampleo), and other suitable polypropylenes. Table B shows the characteristics of selected propylene based polymers. g′ᵥᵢₛ can be measured using GPC-4D. Techniques for determining the molecular properties are described below.

TABLE B

| Grade | Mw (g/mol) | Mw/Mn | LCB-g'ᵥᵢₛ |
|---|---|---|---|
| ExxonMobil ™ PP5341 | 562,000 | 7.5 | 1.000 |
| EXP-PP | 540,000 | 16 | 0.857 |

g'ᵥᵢₛ is measured using GPC-4D.

In one or more embodiments, the thermoplastic component can be or can include isotactic polypropylene. In some embodiments, the thermoplastic component can contain one or more crystalline propylene homopolymers or copolymers of propylene having a melting temperature of from about 110° C. to about 170° C. or higher as measured by DSC. Example copolymers of propylene can include terpolymers of propylene, impact copolymers of propylene, random polypropylene, and mixtures thereof. Example comonomers can have about 2 carbon atoms or from about 4 to about 12 carbon atoms. In some embodiments, the comonomer can be ethylene.

The term “random polypropylene” as used herein broadly means a single phase copolymer of propylene having up to about 9 wt %, such as from about 2 wt % to about 8 wt % of an alpha olefin comonomer. Example alpha olefin comonomers can have about 2 carbon atoms or from about 4 to about 12 carbon atoms. In some embodiments, the alpha olefin comonomer can be ethylene.

In one or more embodiments, the thermoplastic phase can be or include a “propylene-based copolymer.” A “propylene-based copolymer” includes at least two different types of monomer units, one of which is propylene. Suitable monomer units can include, but are not limited to, ethylene and higher alpha-olefins ranging from C4 to C20, such as, for example, 1-butene, 4-methyl-1-pentene, 1-hexene or 1-octene and 1-decene, or mixtures thereof, for example. In some embodiments, ethylene can be copolymerized with propylene, so that the propylene-based copolymer includes propylene-derived units (units on the polymer chain derived from propylene monomers) and ethylene-derived units (units on the polymer chain derived from ethylene monomers).

### 2. Ethylene-Based Polymer

Ethylene-based polymers can include those solid, generally high-molecular weight plastic resins that primarily include units derived from the polymerization of ethylene. In some embodiments, at least 90%, or at least 95%, or at least 99% of the units of the ethylene-based polymer can derive from the polymerization of ethylene. In particular embodiments, these polymers can include homopolymers of ethylene.

In some embodiments, the ethylene-based polymers may also include units deriving from the polymerization of α-olefin comonomer such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene-based polymer can include one or more of the following characteristics:

1) A melt index (MI) (ASTM D-1238, 2.16 kg @ 190° C.) that can be from about 0.1 dg/min to about 1,000 dg/min, such as from about 1.0 dg/min to about 200 dg/min, such as from about 7.0 dg/min to about 20.0 dg/min.

2) A melt temperature (Tm) that can be from about 140° C. to about 90° C., such as from about 135° C. to about 125° C., such as from about 130° C. to about 120° C.

The ethylene-based polymers may be synthesized by using an appropriate polymerization technique known in the art such as the conventional Ziegler-Natta type polymerizations, and catalysis employing single-site organometallic catalysts including metallocene catalysts. Some ethylene-based polymers are commercially available. Ethylene-based copolymers are commercially available under the trade name ExxonMobil™ Polyethylene (available from ExxonMobil of Houston, Tex.), which include metallocene produced linear low density polyethylene including Exceed™, Enable™, and Exceed™ XP. Examples of ethylene-based thermoplastic polymers useful for certain embodiments of the present TPV compositions (and/or TPO compositions) described herein can include ExxonMobil HD7800P, ExxonMobil HD6706.17, ExxonMobil HD7960.13, ExxonMobil HD9830, ExxonMobil AD60-007, Exceed XP 8318ML, Exceed™ XP 6056ML, Exceed 1018HA, Enable™ 2010 Series, Enable™ 2305 Series, and ExxonMobil™ LLDPE LL (e.g. 1001, 1002YB, 3003 Series), all available from ExxonMobil of Houston, Tex. Additional examples of ethylene-based thermoplastic polymers useful for certain embodiments of the present TPV compositions (and/or TPO compositions) described herein can include Innate™ ST50 and Dowlex™, available from The Dow Chemical Company of Midland, Mich.

In some embodiments, the ethylene-based polymer can include a low density polyethylene, a linear low density polyethylene, or a high density polyethylene. In some embodiments, the ethylene-based polymer can be a high melt strength (HMS) long chain branched (LCB) homopolymer polyethylene.

### 3. Butene-1-Based Polymer

Butene-1-based polymers can include those solid, generally high molecular weight isotactic butene-1 resins that primarily include units deriving from a polymerization of butene-1.

In some embodiments, the butene-1-based polymers can include isotactic poly(butene-1) homopolymers. In some embodiments, the butene-1-based polymers may also include units deriving from the polymerization of α-olefin comonomer such as ethylene, propylene, 1-butene, 1-hexane, 1-octene, 4-methyl-1-pentene, 2-methyl-1-propene, 3-methyl-1-pentene, 4-methyl-1-pentene, 5-methyl-hexene, and mixtures thereof.

In some embodiments, the butene-1-based polymer can include one or more of the following characteristics:

1) At least 90 wt % or more of the units of the butene-1-based polymer can derive from the polymerization of butene-1, such as about 95 wt % or more, such as about 98 wt % or more, such as about 99 wt % or more. In some embodiments, these polymers can include homopolymers of butene-1.
2) A melt index (MI) (ASTM D1238, 2.16 kg @ 190° C.) that can be about 0.1 dg/min to 800 dg/min, such as from about 0.3 dg/min to about 200 dg/min, such as from about 0.3 dg/min to about 4.0 dg/min. In these or other embodiments, the MI can be about 500 dg/min or less, such as about 100 dg/min or less, such as about 10 dg/min or less, such as about 5 dg/min or less.
3) A melt temperature (Tm) that can be from about 130° C. to about 110° C., such as from about 125° C. to about 115° C., such as from about 125° C. to about 120° C.
4) A density, as determined according to ASTM D792, that can be from about 0.897 g/ml to about 0.920 g/ml, such as from about 0.910 g/ml to about 0.920 g/ml. In these or other embodiments, a density that can be about 0.910 g/ml or more, such as 0.915 g/ml or more, such as about 0.917 g/ml or more.

The butene-1-based polymers may be synthesized by using an appropriate polymerization technique known in the art such as the conventional Ziegler-Natta type polymerizations, and catalysis employing single-site organometallic catalysts including metallocene catalysts. Some butene-1-based polymers are commercially available. For example, some isotactic poly(l-butene) is commercially available under the tradename Polybutene Resins or PB (Basell).

### 4. Cyclic Olefin Copolymer

In at least one embodiment, the thermoplastic phase can be a cyclic olefin copolymer (COC). The COC can be a semi-crystalline cyclic olefin copolymer of one or more residues of norbornene and ethylene, a bridged polycyclic hydrocarbon, a cyclo ethylene copolymer, a cyclic olefin polymer, ethylene norbornene copolymers, ethylene cyclopentene copolymers, poly norbornene, poly dicyclo pentadiene, and ring opened dicyclo pentadiene copolymers, or a combination thereof.

Useful COCs can be made using vanadium, Ziegler-Natta, and metallocene catalysts. Examples of suitable catalysts are disclosed in U.S. Pat. Nos. 4,614,778 and 5,087,677, for example. Presently, there exist numerous grades of commercially available cyclic olefin copolymers based on different types of cyclic monomers and polymerization methods. Cyclic olefin copolymers are typically produced by chain copolymerization of cyclic monomers such as 8,9,10-trinorborn-2-ene (norbornene) or 1,2,3,4,4a,5,8,8a-octahydro-1,4:5,8-dimethanonaphthalene (tetracyclododecene) with ethene.

Non-limiting examples of commercially available cyclic olefin copolymers can include those available from TOPAS Advanced Polymers under the designation TOPAS, Mitsui Chemical's APEL, or those formed by ring-opening metathesis polymerization of various cyclic monomers followed by hydrogenation, which are available from Japan Synthetic Rubber under the designation ARTON, and Zeon Chemical's ZEONEX and ZEONOR.

In at least one embodiment, the COC can include a copolymer of cyclic monomers such as norbornene in the range of from about 60 wt % to about 90 wt % and ethylene. In some embodiments, the COC can have a glass transition of from about 40° C. to about 200° C., such as from about 60° C. to about 160° C.; and/or an MFR (260° C., 2.16 kg) of from about 1 ml/10 min to about 60 ml/10 min, such as from about 4 ml/10 min to about 50 ml/10 min.

Table C shows non-limiting examples of thermoplastic phases along with their thermal conductivities and Vicat softening point. Selection of the thermoplastic phase for the TPV composition (and/or TPO compositions) can be based on the thermal conductivity and/or Vicat softening point of the thermoplastic phase. In Table C, PPO-PP refers to a polymer blend of PP with polyphenylene oxide, P4MP refers to poly(4-methyl-1-pentene), PP refers to polypropylene, and COC refers to cyclic olefin copolymer. An example of PPO-PP is Noryl™ GTX, and examples of P4MP are commercially available from Mitsui Chemicals.

TABLE C

| Thermoplastic | Vicat softening | Thermal Conductivity |
|---|---|---|
| Phase | point (° C.) | (W/m · K) |
| PPO-PP | 138 | 0.20 |
| P4MP | 170 | 0.17 |
| PP | 150 | 0.20 |
| COC | 180 | 0.15 |

### Other Constituents

In some embodiments, the TPV compositions (and/or TPO compositions) may include a polymeric processing additive. The processing additive may be a polymeric resin that has a very high melt flow index. These polymeric resins can include both linear and branched polymers that can have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives can include polypropylene homopolymers, and branched polymeric processing additives can include diene-modified polypropylene polymers. TPV compositions that include similar processing additives are disclosed in U.S. Pat. No. 6,451,915, which is incorporated herein by reference for purpose of U.S. patent practice.

In some embodiments, the TPV compositions (and/or TPO compositions) of the present disclosure may optionally include reinforcing and non-reinforcing fillers, antioxidants, stabilizers, rubber processing oil, lubricants, antiblocking agents, anti-static agents, waxes, foaming agents, pigments, flame retardants, nucleating agents, and other processing aids known in the rubber compounding art. These additives can comprise up to about 50 weight percent of the total composition.

Fillers and extenders that can be utilized include conventional inorganics such as calcium carbonate, clays, silica, talc, titanium dioxide, carbon black, a nucleating agent, mica, wood flour, and the like, and blends thereof, as well as inorganic and organic nanoscopic fillers.

### Nucleating Agent

The term “nucleating agent” means any additive that produces a nucleation site for thermoplastic crystals to grow from a molten state to a solid, cooled structure. In other words, nucleating agents provide sites for growing thermoplastic crystals upon cooling the thermoplastic from its molten state.

The nucleating agent can provide a plurality of nucleating sites for the thermoplastic component to crystallize when cooled. Surprisingly, this plurality of nucleating sites can promote even crystallization within the TPV composition (and/or TPO composition), allowing the composition to crystallize throughout an entire cross section in less time and at higher temperature. This plurality of nucleating site can produce a greater amount of smaller crystals within the TPV composition (and/or TPO composition) which require less cooling time.

This even cooling distribute enables the formation of extruded articles of the present TPV compositions (and/or TPO compositions) having a thickness greater than 2 mm, such as greater than 5 mm, greater than 10 mm, and even greater than 15 mm Extruded articles of the present TPV compositions (and/or TPO compositions) can have thicknesses greater than 20 mm and still exhibit effective cooling (e.g., cooling from an outer surface of the cross section to an inner surface of the cross section) at extrusion temperatures without sacrificing mechanical strength. Such extrusion temperatures can be at or above the melting point of the thermoplastic component. Illustrative nucleating agents can include dibenzylidene sorbitol based compounds, sodium benzoate, sodium phosphate salts, as well as lithium phosphate salts. For example, the nucleating agent may include sodium 2,2′-methylene-bis-(2,6-di-tert-butylphenyl)phosphate which is commercially available from Milliken & Company of Spartanburg, S.C. under the trade name Hyperform™. Another specific nucleating agent is norbornane (bicyclo(2.2.1)heptane carboxylic acid salt, which is commercially available from CIBA Specialty Chemicals of Basel, Switzerland.

### Processing Oils/Plasticizers

In some embodiments, the TPV composition (and/or TPO composition) may include a plasticizer such as an oil, such as a mineral oil, a synthetic oil, or a combination thereof. These oils may also be referred to as plasticizers or extenders. Mineral oils may include aromatic, naphthenic, paraffinic, and isoparaffinic oils, synthetic oils, and a combination thereof. In some embodiments, the mineral oils may be treated or untreated. Useful mineral oils can be obtained under the tradename SUNPAR™ (Sun Chemicals). Other useful oils are available under the name PARALUX™ (Chevron), and PARAMOUNT™ (Chevron). Other oils that may be used include hydrocarbon oils and plasticizers, such as synthetic plasticizers. Many additive oils are derived from petroleum fractions, and have particular ASTM designations depending on whether they fall into the class of paraffinic, naphthenic, or aromatic oils. Other types of additive oils can include alpha olefinic synthetic oils, such as liquid polybutylene and polyisobutylene. Additive oils other than petroleum based oils can also be used, such as oils derived from coal tar and pine tar, as well as synthetic oils, e.g., polyolefin materials. Other plasticizers can include triisononyl trimellitate (TINTM). In addition, vegetable or animal oils may be also used as plasticizer and/or processing aid in the TPV composition (and/or TPO composition).

Examples of oils can include base stocks. According to the American Petroleum Institute (API) classifications, base stocks are categorized in five groups based on their saturated hydrocarbon content, sulfur level, and viscosity index (Table D). Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing. See “New Lubes Plants Use State-of-the-Art Hydrodewaxing Technology” in Oil & Gas Journal, Sep. 1, 1997; Krishna et al., “Next Generation Isodewaxing and Hydrofinishing Technology for Production of High Quality Base Oils”, 2002 NPRA Lubricants and Waxes Meeting, Nov. 14-15, 2002; Gedeon and Yenni, “Use of “Clean” Paraffinic Processing Oils to Improve TPE Properties”, Presented at TPEs 2000 Philadelphia, Pa., Sep. 27-28, 1999.

Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE D

| API | Group | Group | Group | Group | Group |
|---|---|---|---|---|---|
| Classification | I | II | III | IV | V |
| % Saturates | <90 | ≥90 | ≥90 | Polyalpha- | All others not |
| % S | >0.03 | ≤0.03 | ≤0.03 | olefins | belonging to |
| Viscosity | 80-120 | 80-120 | ≥120 | (PAOs) | Groups I-IV |
| Index (VI) | | | | | |

In some embodiments, synthetic oils can include polymers and oligomers of butenes including isobutene, 1-butene, 2-butene, butadiene, and mixtures thereof. In some embodiments, these oligomers can be characterized by a number average molecular weight (Mn) of from about 300 g/mol to about 9,000 g/mol, and in other embodiments from about 700 g/mol to about 1,300 g/mol. In some embodiments, these oligomers can include isobutenyl mer units. Exemplary synthetic oils can include polyisobutylene, poly(isobutylene-co-butene), and mixtures thereof. Exemplary polyisobutylenes can include liquid polyisobutylene oils having an Mn in the range of from about 600 g/mol to about 6,000 g/mol and from about 20 phr (parts by weight per 100 parts of block copolymer) to 100 phr of polyolefin hardener. In some embodiments, synthetic oils may include polylinear α-olefins, poly-branched α-olefins, hydrogenated polyalphaolefins, and mixtures thereof.

In some embodiments, the synthetic oils can include synthetic polymers or copolymers having a viscosity of about 20 cp or more, such as about 100 cp or more, such as about 190 cp or more, where the viscosity is measured by a Brookfield viscometer according to ASTM D-4402 at 38° C. In these or other embodiments, the viscosity of these oils can be about 4,000 cp or less, such as about 1,000 cp or less.

Useful synthetic oils can be commercially obtained under the tradenames Polybutene™ (Soltex; Houston, Tex.), and Indopol™ (Ineos). White synthetic oil is available under the tradename SPECTRASYN™ (ExxonMobil), formerly SHF Fluids (Mobil), Elevast™ (ExxonMobil), and white oil produced from gas to liquid technology such as Risella™ X 415/420/430 (Shell) or Primol™ (ExxonMobil) series of white oils, e.g. Primol™ 352, Primol™ 382, Primol™ 542, or Marcol™ 82, Marcol™ 52, Drakeol® (Pencero) series of white oils, e.g. Drakeol® 34 or combinations thereof. Oils described in U.S. Pat. No. 5,936,028 may also be employed.

In some embodiments, the addition of certain low to medium molecular weight (<10,000 g/mol) organic esters and alkyl ether esters to the present TPV compositions (and/or TPO compositions) can dramatically lower the Tg of the polyolefin and rubber components and of the overall composition. The addition of certain low to medium molecular weight (<10,000 g/mol) organic esters and alkyl ether esters can improve the low temperature properties, particularly flexibility and strength. It is believed that these effects are achieved by the partitioning of the ester into both the polyolefin and rubber components of the compositions. Particularly suitable esters can include monomeric and oligomeric aliphatic esters having a low molecular weight, such as an average molecular weight in a range from about 2000 or below, such as about 600 or below. In certain aspects, the ester can be selected to be compatible, or miscible, with both the polyolefin and rubber components of the compositions, e.g., that the ester mixes with the other components to form a single phase. The esters can include monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof.

Examples of esters suitable for use in the present TPV compositions (and/or TPO compositions) can include diisooctyldodecanedioate, dioctylsebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof. Other analogues useful in the present TPV compositions (and/or TPO compositions) can include alkyl alkylether monoadipates and diadipates, monoalkyl and dialkyl adipates, glutarates, sebacates, azelates, ester derivatives of castor oil or tall oil, and oligomeric monoesters and diesters or monoalkyl and dialkyl ether esters therefrom. Isooctyltallate and n-butyltallate can be useful. These esters may be used alone in the compositions, or as mixtures of different esters, or they may be used in combination with conventional hydro carbon oil diluents or processing oils, e.g., paraffin oil. In certain embodiments, the amount of ester plasticizer in the TPV composition (and/or TPO composition) can be from about 0.1 wt % to about 40 wt % based upon a total weight of the TPV composition (and/or TPO composition). Such esters are available commercially as Plasthall™ available from Hallstar of Chicago, Ill.

### Preparation of TPV Compositions and TPO Compositions

In some embodiments, the rubber can be partially or fully cured or crosslinked by dynamic vulcanization. The term dynamic vulcanization refers to a vulcanization or curing process for a rubber contained in a blend with a thermoplastic component, wherein the rubber is crosslinked or vulcanized under conditions of high shear at a temperature above the melting point of the thermoplastic component. The rubber can be cured by employing a variety of curatives. Exemplary curatives can include phenolic resin cure systems, peroxide cure systems, and silicon-containing cure systems, such as hydrosilylation and silane grafting/moisture cure. Dynamic vulcanization can occur in the presence of the polyolefin, or the polyolefin can be added after dynamic vulcanization (e.g., post added), or both (e.g., some polyolefin can be added prior to dynamic vulcanization and some polyolefin can be added after dynamic vulcanization).

In some embodiments, the rubber can be simultaneously crosslinked and dispersed as fine particles within the thermoplastic matrix, although other morphologies may also exist. Dynamic vulcanization can be effected by mixing the thermoplastic elastomer components at elevated temperature in conventional mixing equipment such as roll mills, stabilizers, Banbury mixers, Brabender mixers, continuous mixers, mixing extruders and the like. Methods for preparing TPV compositions are described in U.S. Pat. Nos. 4,311,628, 4,594,390, 6,503,984, and 6,656,693, although methods employing low shear rates can also be used. Multiple-step processes can also be employed whereby ingredients, such as additional thermoplastic component, can be added after dynamic vulcanization has been achieved as disclosed in International Application No. PCT/US04/30517.

In some embodiments, the rubber is not cured or crosslinked.

In some embodiments, a process for the preparation of the TPV composition (and/or TPO composition) can include melt processing under shear conditions of at least one thermoplastic component, at least one rubber component, and at least one curing agent. In some embodiments, the melt processing can be performed under high shear conditions. Shear conditions are similar to conditions that exist when the TPV compositions (and/or TPO compositions) are produced using common melt processing equipment such as Brabender or Banbury mixers (lab scale instruments) and commercial twin-screw extruders.

The word shear is added to indicate that the TPV compositions (and/or TPO compositions) can be made by mixing under high shear temperature and intense mixing.

The skilled artisan will be able to readily determine a sufficient or effective amount of vulcanizing agent to be employed without undue calculation or experimentation.

As noted above, the TPV compositions are dynamically vulcanized by a variety of methods including employing a cure system, wherein the cure system comprises a curative, such as a phenolic resin curative, a peroxide curative, a maleimide curative, a hexamethylene diamine carbamate curative, a silicon-based curative (including hydrosilylation curative, a silane-based curative such as a silane grafting followed by moisture cure), metal oxide-based curative (such as ZnO for butyl rubbers), sulfur-based curative, or a combination thereof.

Useful phenolic cure systems are disclosed in U.S. Pat. Nos. 2,972,600, 3,287,440, 5,952,425 and 6,437,030.

In some embodiments, phenolic resin curatives can include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between about 1 and about 10 carbon atoms. In some embodiments, a blend of octylphenol-formaldehyde and nonylphenol-formaldehyde resins can be employed. The blend can include from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. In some embodiments, the blend can include about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in paraffinic oil at about 30% solids without phase separation.

Useful phenolic resins may be obtained under the tradenames SP-1044, SP-1045 (Schenectady International; Schenectady, N.Y.), which may be referred to as alkylphenol-formaldehyde resins.

An example of a phenolic resin curative can include that defined according to the general formula

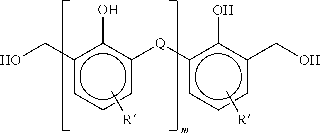

where Q is a divalent radical selected from the group consisting of —CH₂—, —CH₂—O—CH₂—; m is zero or a positive integer from 1 to 20 and R is an organic group. In some embodiments, Q can be the divalent radical —CH₂—O—CH₂—, m can be zero or a positive integer from 1 to 10, and/or R can be an organic group having less than 20 carbon atoms. In other embodiments, m can be zero or a positive integer from 1 to 10 and/or R can be an organic radical having from 4 and 12 carbon atoms.

In some embodiments, the phenolic resin can be used in combination with a halogen source, such as stannous chloride, and metal oxide or reducing compound such as zinc oxide.

In some embodiments, the phenolic resin may be employed in an amount from about 2 parts by weight to about 6 parts by weight, such as from about 3 parts by weight to about 5 parts by weight, such as from about 4 parts by weight to about 5 parts by weight per 100 parts by weight of rubber. A complementary amount of stannous chloride may include from about 0.5 parts by weight to about 2.0 parts by weight, such as from about 1.0 parts by weight to about 1.5 parts by weight, such as from about 1.2 parts by weight to about 1.3 parts by weight per 100 parts by weight of rubber. In conjunction therewith, from about 0.1 parts by weight to about 6.0 parts by weight, such as from about 1.0 parts by weight to about 5.0 parts by weight, such as from about 2.0 parts by weight to about 4.0 parts by weight of zinc oxide may be employed. In some embodiments, the olefinic rubber employed with the phenolic curatives can include diene units deriving from 5-ethylidene-2-norbornene.

In some embodiments, useful peroxide curatives can include organic peroxides. Examples of organic peroxides can include di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Useful peroxides and their methods of use in dynamic vulcanization of TPV compositions are disclosed in U.S. Pat. No. 5,656,693, which is incorporated herein by reference.

In some embodiments, the peroxide curatives can be employed in conjunction with a coagent. Examples of coagents can include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking, the mixing and dynamic vulcanization may be carried out in a nitrogen atmosphere.

In some embodiments, silicon-containing cure systems may include silicon hydride compounds having at least two Si—H groups. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof.

Useful catalysts for hydrosilylation can include transition metals of Group VIII. These metals can include palladium, rhodium, and platinum, as well as complexes of these metals. Useful silicon-containing curatives and cure systems are disclosed in U.S. Pat. Nos. 5,936,028, 4,803,244, 5,672,660, and 7,951,871.

In some embodiments, the silane-containing compounds may be employed in an amount from about 0.5 parts by weight to about 5.0 parts by weight per 100 parts by weight of rubber, such as from about 1.0 parts by weight to about 4.0 parts by weight, such as from about 2.0 parts by weight to about 3.0 parts by weight. A complementary amount of catalyst may include from about 0.5 parts of metal to about 20.0 parts of metal per million parts by weight of the rubber, such as from about 1.0 parts of metal to about 5.0 parts of metal, such as from about 1.0 parts of metal to about 2.0 parts of metal. In some embodiments, the olefinic rubber employed with the hydrosilylation curatives can include diene units deriving from 5-vinyl-2-norbornene. Exemplary hydrosilylation curatives can include Xiameter™ OFX-5084 Fluid available from Dow Chemical Company.

A phenolic resin can be employed in an amount of about 2 parts by weight to about 10 parts by weight per 100 parts by weight rubber, such as from about 3.5 parts by weight to about 7.5 parts by weight, such as from about 5 parts by weight to about 6 parts by weight. In some embodiments, the phenolic resin can be employed in conjunction with stannous chloride and optionally zinc oxide. The stannous chloride can be employed in an amount from about 0.2 parts by weight to about 10 parts by weight per 100 parts by weight rubber, such as from about 0.3 parts by weight to about 5 parts by weight, such as from about 0.5 parts by weight to about 3 parts by weight. The zinc oxide can be employed in an amount from about 0.25 parts by weight to about 5 parts by weight per 100 parts by weight rubber, such as from about 0.5 parts by weight to about 3 parts by weight, such as from about 1 parts by weight to about 2 parts by weight.

Alternately, in some embodiments, a peroxide can be employed in an amount from about 1×10⁻⁵ moles to about 1×10⁻¹ moles, such as from about 1×10⁻⁴ moles to about 9×10⁻² moles, such as from about 1×10⁻² moles to about 4×10⁻² moles per 100 parts by weight rubber. The amount may also be expressed as a weight per 100 parts by weight rubber. This amount, however, may vary depending on the curative employed. For example, where 4,4-bis(tert-butyl peroxy) diisopropyl benzene is employed, the amount employed may include from about 0.5 parts by weight to about 12 parts by weight, such as from about 1 parts by weight to about 6 parts by weight per 100 parts by weight rubber. The skilled artisan will be able to readily determine a sufficient or effective amount of coagent that can be used with the peroxide without undue calculation or experimentation. In some embodiments, the amount of coagent employed can be similar in terms of moles to the number of moles of curative employed. The amount of coagent may also be expressed as weight per 100 parts by weight rubber. For example, where the triallylcyanurate coagent is employed, the amount employed can include from about 0.25 phr to about 20 phr, such as from about 0.5 phr to about 10 phr, based on 100 parts by weight rubber.

### Slip Agent

In certain embodiments, the present TPV compositions (and/or TPO compositions) may optionally include a slip agent when the crosslinked rubber is cured with a phenolic or peroxide based cure systems. Slip agents can be defined as class of fillers or additives intended to reduce the coefficient of friction of the TPV composition (and/or TPO composition) while also improving the abrasion resistance. Examples of slip agents can include siloxane based additives (such as polysiloxanes), ultra-high molecular weight polyethylene, a blend of siloxane based additives (such as polysiloxanes) and ultra-high molecular weight polyethylene, molybdenum disulfide molybdenum disulfide, halogenated and unhalogenated compounds based on aliphatic fatty chains, fluorinated polymers, perfluorinated polymers, graphite, and a combination thereof. The slip agents can be selected with a molecular weight suitable for the use in oil, paste, or powder form.

Slip agents useful in the TPV composition (and/or TPO composition) can include fluorinated or perfluorinated polymers, such as Kynar™ (available from Arkema of King of Prussia, Pa.), Dynamar™ (available from 3M of Saint Paul, Minn.), molybdenum disulfide, or compounds based on aliphatic fatty chains, whether halogenated or not, or polysiloxanes. In some embodiments, the slip agents can be of the migratory type or non-migratory type.

In some embodiments, the polysiloxane can comprise a migratory siloxane polymer which is a liquid at standard conditions of pressure and temperature. A suitable polysiloxane can be a high molecular weight, essentially linear polydimethyl-siloxane (PDMS). Additionally, the polysiloxane may have a viscosity at room temperature in a range from about 100 to about 100,000 cSt, such as from about 1,000 to about 10,000 cSt, or from about 5,000 cSt to about 10,000 cSt.

In certain embodiments, polysiloxane can also contain R groups that can be selected based on the cure mechanism desired for the composition containing the first polysiloxane. Typically, the cure mechanism is either by means of condensation cure or addition cure, but is generally via an addition cure process. For condensation reactions, two or more R groups per molecule should be hydroxyl or hydrolysable groups such as alkoxy group having up to about 3 carbon atoms. For addition reactions, and in some embodiments, two or more R groups per molecule may be unsaturated organic groups, typically alkenyl or alkynyl groups, such as up to about 8 carbon atoms. One suitable commercially available material useful as the first polysiloxane is XIAMETER™ PMX-200 Silicone Fluid available from Dow Corning Midland, Mich. In certain embodiments, the TPV compositions (and/or TPO compositions) described herein can contain polysiloxane in a range from about 0.2 wt % to about 20 wt %, such as from about 0.5 wt % to about 15 wt % or from about 0.5 wt % to about 10 wt %.

In certain embodiments, polysiloxane, such as polyorganosiloxanes, can comprise a non-migratory polysiloxane which is bonded to a thermoplastic material. The polysiloxane can be reactively dispersed in a thermoplastic material, which may be any homopolymer or copolymer of ethylene and/or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. In at least one embodiment, the thermoplastic material can be a polypropylene homopolymer. Suitable methods of reactively bonding a polysiloxane to an organic thermoplastic polymer, such as a polyolefin, are disclosed in International Patent Publication Nos. WO2015/132190 and WO2015/150218, the entire contents of which are incorporated herein by reference for U.S. patent practice.

In some embodiments, the polysiloxane may comprise predominantly D and/or T units and contains some alkenyl functionalities, which assist in the reaction with the polymer matrix. In some embodiments, there can be a covalent bond between the polysiloxane and the polypropylene. In some embodiments, the reaction product of polysiloxane and the polypropylene can have a number average molecular weight in a range from about 0.2 kg/mol to about 100 kg g/mole. The number average molecular weight of the reaction product of the polyorganosiloxane and the polymer matrix can be at least 1.1 times, such as at least 1.3 times, the number average molecular weight of the base polyorganosiloxane. In some embodiments, the second polyorganosiloxane can have a gum loading of in a range from about 20 wt % and about 50 wt %.

One example of a slip agent is HMB-0221. HMB-0221 is provided as pelletized concentrate containing reaction products of ultrahigh molecular weight siloxane polymer reactively dispersed in polypropylene homopolymer. HMB-0221 is available from Dow Corning of Midland, Mich. In certain embodiments, the TPV compositions (and/or TPO compositions) described herein can contain a non-migratory polysiloxane in a range from about 0.2 wt % to about 20 wt %, such as from about 0.2 wt % to about 15 wt % or from about 0.2 wt % to about 10 wt %.

Other optional components in the TPV composition (and/or TPO composition) can include high density polyethylene (HDPE) and/or high modulus polyethylene (HMPE) for improved abrasion resistance.

### Properties of the TPV Compositions and the TPO Compositions

In at least one embodiment, the TPV composition (and/or TPO composition) can include a polypropylene as the thermoplastic phase, and the polypropylene can have an MFR (ASTM D1238, 2.16 kg weight @ 230° C.) of about 0.1 g/10 min or more, such as from about 0.1 g/10 min to about 50 g/10 min, such as from about 0.1 g/10 min to about 10 g/10 min, such as from about 0.2 g/10 min to about 5 g/10 min, such as from about 0.5 g/10 min to about 3 g/10 min; and/or a weight average molecular weight (Mw) of from about 50,000 g/mol to about 2,000,000 g/mol, such as from about 100,000 g/mol to about 1,000,000 g/mol, such as from about 200,000 g/mol to about 600,000 g/mol or from about 400,000 g/mol to about 800,000 g/mol) as measured by GPC with polystyrene standards.

In at least one embodiment, the TPV composition (and/or TPO composition) can include a polypropylene as the thermoplastic phase, and the polypropylene can be a homopolymer or random copolymer or impact copolymer polypropylene, such as a high melt strength (HMS) long chain branched (LCB) homopolymer polypropylene.

In at least one embodiment, the TPV composition (and/or TPO composition) can have a hardness that is from about 20 Shore A to about 70 Shore D, such as from about 30 Shore D to about 50 Shore D. Shore A Shore D Hardness was measured using a Zwick automated durometer according to ASTM D2240.

In at least one embodiment, the TPV composition (and/or TPO composition) can have an initial thermal conductivity of about 0.2 W/m·K or less, such as about 0.19 W/m·K or less, such as about 0.18 W/m·K or less, such as about 0.17 W/m·K or less, such as about 0.16 W/m·K or less, such as about 0.15 W/m·K or less, such as about 0.14 W/m·K or less. In at least one embodiment the TPV composition (and/or TPO composition) can have an initial thermal conductivity of from about 0.13 W/m·K to about 0.20 W/m·K, such as from about 0.14 W/m·K to about 0.19 W/m·K or from about 0.15 W/m·K to about 0.18 W/m·K or from about 0.14 W/m·K to about 0.16 W/m·K.

In at least one embodiment, the TPV composition (and/or TPO composition) can have a thermal conductivity that exhibits a very small change in thermal conductivity when exposed to heat and/or water (e.g., seawater).

In at least one embodiment, the TPV composition (and/or TPO composition) can have a high tensile modulus measured at 23° C. The tensile modulus can be about 50 MPa or more, such as about 100 MPa or more, such as about 125 MPa or more, such as about 140 MPa or more, such as about 300 or more.

In at least one embodiment, the TPV composition (and/or TPO composition) can have a high compressive strength measured at 23° C. The compressive strength can be about 10 MPa or more, such as about 25 MPa or more, such as about 100 MPa or more, such as from about 10 MPa to about 1000 MPa, such as from about 50 MPa to about 750 MPa, such as from about 100 MPa to about 600 MPa, such as from about 100 MPa to about 500 MPa.

In at least one embodiment, the TPV composition (and/or TPO composition) can have a high specific heat capacity at 110° C. The specific heat capacity can be about 1000 J/kg·K or more, such as about 1300 J/kg·K or more, such as about 2000 J/kg·K or more, such as about 2300 J/kg·K or more, such as about 2500 J/kg·K or more, such as about 2600 J/kg·K or more, such as about 3000 J/kg·K or more. In at least one embodiment, the specific heat capacity can be from about 1000 J/kg·K to about 5000 J/kg·K, such as from about 1300 J/kg·K to about 4000 J/kg·K, such as from about 1000 J/kg·K to about 3500 J/kg·K, such as from about 2000 J/kg·K to about 3300 J/kg·K.

In at least one embodiment, the TPV composition (and/or TPO composition) can exhibit an ability to withstand temperatures of about 100° C. or more, such as from about 100° C. to about 200° C., such as from about 105° C. to about 160° C., such as from about 110° C. to about 150° C. or from about 150° C. to about 180° C.

In some embodiments, the TPV composition (and/or TPO composition) can exhibit a tensile strength at yield measured at 23° C. of about 5 MPa or more, such as from about 7 MPa to about 25 MPa, such as from about 10 MPa to about 20 MPa, such as from about 15 MPa to about 18 MPa or from about 12 MPa to about 15 MPa.

In some embodiments, the TPV composition (and/or TPO composition) can exhibit a tensile strength at break measured at 23° C. of about 5 MPa or more, such as from about 7 MPa to about 25 MPa, such as from about 10 MPa to about 20 MPa, such as from about 15 MPa to about 18 MPa or from about 12 MPa to about 15 MPa.

In some embodiments, the TPV composition (and/or TPO composition) can exhibit adequate ductility and/or can have an elongation at break at 23° C. of 10% or more, such as about 100% or more, such as about 250% or more, such as about 500% or more. In at least one embodiment, the TPV composition (and/or TPO composition) can exhibit an elongation at break of from about 10% to about 1,000%, such as from about 100% to about 900%, such as from about 200% to about 800%, such as from about 300% to about 700%, such as from about 400% to about 600%, such as from about 450% to about 550%.

In some embodiments, the TPV composition (and/or TPO composition) can exhibit a Young's modulus (at 23° C.) of about 50 MPa or more, such as about 100 MPa or more, such as about 500 MPa or more. In at least one embodiment, the TPV composition (and/or TPO composition) can exhibit a Young's modulus (at 23° C.) of from about 50 MPa to about 1000 MPa, such as from about 100 MPa to about 900 MPa, such as from about 200 MPa to about 800 MPa, such as from about 300 MPa to about 700 MPa, such as from about 400 MPa to about 600 MPa, such as from about 500 MPa to about 550 MPa.

In some embodiments, the TPV composition (and/or TPO composition) can exhibit a Young's modulus (at 90° C.) of about 50 MPa or more, such as about 100 MPa or more, such as about 500 MPa or more. In at least one embodiment, the TPV composition (and/or TPO composition) can exhibit a Young's modulus (at 23° C.) of from about 50 MPa to about 1000 MPa, such as from about 100 MPa to about 500 MPa, such as from about 200 MPa to about 400 MPa, such as from about 250 MPa to about 350 MPa.

In some embodiments, the TPV composition (and/or TPO composition) can exhibit a coefficient of linear thermal expansion (μm/m·° C.) of about 50 μm/m° C. or more, such as about 100 μm/m·° C. or more. In at least one embodiment, the TPV composition (and/or TPO composition) can exhibit a coefficient of linear thermal expansion (μm/m·° C.) of from about 50 μm/m·° C. to about 250 μm/m·° C., such as from about 100 μm/m·° C. to about 200 μm/m·° C., such as from about 110 μm/m·° C. to about 150 μm/m·° C.

In some embodiments, the TPV composition (and/or TPO composition) can exhibit a creep time to reach 10⁻⁸ compliance by DMTA (at 20° C.) of about 100 seconds (s) or more, such as about 500 s or more, such as about 1000 s or more, such as about 1500 s or more, such as about 2000 s or more. In at least one embodiment, the TPV composition (and/or TPO composition) can exhibit a creep time to reach 10⁻⁸ compliance by DMTA (at 20° C.) of from about 100 s to about 3000 s, such as from about 500 s to about 2500 s, such as from about 1000 s to about 2000 s.

In some embodiments, the TPV composition (and/or TPO composition) can exhibit a water absorption (at room temperature for 28 days) of less than 5%, such as less than 3%, such as less than 2%, such as less than 1%.

In some embodiments, the TPV composition (and/or TPO composition) can exhibit a density of about 0.91 g/cm³ or more, such as from about 0.91 g/cm³ to about 0.94 g/cm³, such as from about 0.915 g/cm³ to about 0.935 g/cm³, such as from about 0.92 g/cm³ to about 0.935 g/cm³, such as from about 0.925 g/cm³ to about 0.93 g/cm³.

In some embodiments, the TPV composition (and/or TPO composition) can have a Tg of about 0° C. or less, such as about −25° C. or less, such as about −35° C. or less, such as about −50° C. or less. In at least one embodiment, the TPV composition (and/or TPO composition) can have a Tg of from about −100° C. to about 0° C., such as from about −80° C. to about −25° C., such as from about −70° C. to about −35° C., such as from about −60° C. to about −50° C.

In at least one embodiment, the TPV composition (and/or TPO composition) can be made in-reactor, in an extruder, or a combination of the two.

Exemplary, but non-limiting TPV composition (and/or TPO composition) can include butyl based rubber TPV those described in U.S. Pat. No. 4,130,534, and nitrile rubber based TPVs described in, e.g., U.S. Pat. Nos. 4,355,139, 4,271,049, and 4,299,931, each of which are incorporated by reference herein in its entirety.

### Embodiments Listing

The present disclosure provides, among others, the following embodiments, each of which may be considered as optionally including any alternate embodiments:

Clause 1. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin.

Clause 2. The conduit according to Clause 1, wherein the composition is a high temperature resistant composition.

Clause 3. The conduit according to claim 1 or claim 2, wherein the composition has a Vicat softening point of from 90° C. to 200° C.

Clause 4. The conduit according to any one of Clauses 1-3, wherein the rubber is at least partially crosslinked.

Clause 5. The conduit according to any one of Clauses 1-4, wherein the rubber is not crosslinked.

Clause 6. The conduit according to any one of Clauses 1-5, wherein the first thermal insulation layer is solid at room temperature.

Clause 7. The conduit according to any one of claims 1-6, wherein the composition comprises hollow microspheres.

Clause 8. The conduit according to any one of claims 1-7, wherein the first thermal insulation layer has one or more of the following properties:

a creep resistance of less than 7%;

a Young's modulus at 23° C. of 50 MPa or more;

a compressive strength at 23° C. of 10 MPa or more;

a specific heat capacity at 110° C. of 1300 J/kg·K or more.

Clause 9. The conduit according to any one of Clauses 1-8, wherein the first thermal insulation layer has a long term temperature withstand capability of >130° C.

Clause 10. The conduit according to any one of Clauses 1-9, wherein the first thermal insulation layer has all of said properties of claims 8 and 9.

Clause 11. The conduit according to any one of Clauses 1-10, wherein the thermoplastic olefin is selected from the group consisting of polypropylene (e.g., homopolymer, random copolymer, or ICP), polyethylene (homopolymer or random copolymer), syndiotactic polystyrene, cyclic olefin copolymer, polyphenylene oxide (PPO) blended with polypropylene, polybutylene terephthalate, polyethylene terephthalate, acrylonitrile butadiene styrene, acrylonitrile styrene acrylate, polyetherimide, polyamide, polymethylpentene polymethylpentene resin (such as a homopolymer or copolymer, e.g., a homopolymer or copolymer of 4-methyl-1-pentene), and a combination thereof.

Clause 12. The conduit according to any one of Clauses 1-11,

wherein the cyclic olefin copolymer comprises norbornene in the range of from about 60 wt % to about 90 wt % and ethylene;

wherein the cyclic olefin copolymer has a glass transition temperature of from about 40° C. to about 200° C., such as from about 60° C. to about 160° C.; and/or

wherein the cyclic olefin copolymer has an MFR (260° C., 2.16 kg) of from about 1 ml/10 min to about 60 ml/10 min, such as from about 4 ml/10 min to about 50 ml/10 min.

Clause 13. The conduit according to any one of Clauses 1-12, wherein the thermoplastic olefin is polyphenylene oxide, or a polyphenylene oxide blended with polypropylene, polystyrene or polyamide.

Clause 14. The conduit according to any one of Clauses 1-13, wherein the composition has a concentration of rubber of from 5 wt % to 50 wt %, and a thermoplastic olefin, based on a combined weight of the rubber and the thermoplastic olefin, and a concentration of the thermoplastic olefin of from 50 wt % to 95 wt % based on the combined weight of the rubber and the thermoplastic olefin, wherein the combined weight of rubber and thermoplastic olefin does not exceed 100 wt %.

Clause 15. The conduit according to any one of Clauses 1-14, wherein the high temperature resistant composition further comprises a plasticizer.

Clause 16. The conduit according to claim 15, wherein the plasticizer is selected from the group consisting of paraffinic oil, low molecular weight ester plasticizer, polyisobutylene, synthetic oil, triisononyl trimellitate, and a combination thereof.

Clause 17. The conduit according to any one of Clauses 1-16, wherein the composition further comprises at least one of a filler and a nucleating agent.

Clause 18. The conduit according to any one of Clauses 1-17, wherein the high temperature resistant composition further comprises a cure system.

Clause 19. The conduit according to Clause 18, wherein the cure system comprises a phenolic resin, a peroxide, a maleimide, a hexamethylene diamine carbamate, a silicon-based curative, a silane-based curative, a sulfur-based curative, or a combination thereof.

Clause 20. The conduit according to Clause 18, wherein the cure system comprises at least one of a hydrosilylation curative, a hydro-siloxane curative, a phenolic resin curative, or a metal oxide.

Clause 21. The conduit according to any one of Clauses 1-20, wherein the composition further comprises calcium carbonate, clay, silica, talc, titanium dioxide, carbon black, mica, wood flour, or a combination thereof.

Clause 22. The conduit according to any one of Clauses 1-21, wherein the rubber has a Mw of from 100,000 g/mol to 3,000,000 g/mol.

Clause 23. The conduit according to any one of Clauses 1-22, wherein the rubber is one or more of a nitrile rubber or a butyl rubber.

Clause 24. The conduit to according any one of Clauses 1-23, wherein the rubber is a butyl rubber selected from the group consisting of isobutylene-isoprene rubber (IIR), brominated isobutylene-isoprene rubber (BIIR), and isobutylene paramethyl styrene rubber (BIMSM).

Clause 25. The conduit according to Clause 24, wherein the butyl rubber is an isobutylene-paramethylstyrene rubber comprising from 0.5 wt % to 25 wt % paramethylstyrene based on an entire weight of the rubber.

Clause 26. The conduit according to Clause 24, wherein the butyl rubber is a brominated isobutylene-isoprene rubber comprising a percent by weight halogenation of from 0.3 wt % to 7 wt % based on an entire weight of the rubber.

Clause 27. The conduit according to any one of Clauses 1-26, wherein the thermoplastic olefin is one or more of a polypropylene, a polyethylene, and a polybutene-1.

Clause 28. The conduit according to any one of Clauses 1-27, wherein the thermoplastic olefin has a Vicat softening point of from 100 to 200° C.

Clause 29. The conduit according to any one of Clauses 1-28, wherein the thermoplastic olefin has a thermal conductivity of no greater than 0.22 W/m·K.

Clause 30. The conduit according to any one of Clauses 15-29, wherein the plasticizer is a paraffinic processing oil such as oil Group I, Group II, Group III, synthetic oils such as PAO, PIB, polybutenes, or alklyl esters, or a combination thereof.

Clause 31. The conduit according to Clause 30, wherein the plasticizer is a liquid polyisobutylene oil having Mn in the range from about 200 to 6000; and, from 20 to 100 phr (parts by weight per 100 parts of block copolymer) of polyolefin hardener.

Clause 32. The conduit according to Clause 30, wherein the plasticizer is a paraffinic oil.

Clause 33. The conduit according to any one of Clauses 1-32, wherein the composition further comprises a siloxane based slip agent.

Clause 34. The conduit according to any one of Clauses 1-33, wherein the composition further comprises a high density polyethylene (HDPE) and/or a high modulus polyethylene (HMPE).

Clause 35. The conduit according to any one of Clauses 1-34, wherein the thermoplastic olefin is a polypropylene having a MFR from 0.1 to 10 g/10 min and/or a Mw of from 100,000 to 1,000,000 g/mol.

Clause 36. The conduit according to any one of Clauses 1-35, wherein the thermoplastic olefin is a polypropylene having a MFR of from 0.5 to 3 g/10 min and/or a Mw of from 400,000 to 800,000 g/mole.

Clause 37. The conduit according to any one of Clauses 1-36, wherein the thermoplastic olefin is a polypropylene homopolymer, polypropylene random copolymer, or an impact copolymer polypropylene.

Clause 38. The conduit according to any one of Clauses 1-37, wherein the thermoplastic olefin is a high melt strength (HMS) long chain branched (LCB) homopolymer PP.

Clause 39. The conduit according to any one of Clauses 1-38, wherein the composition has a Shore hardness of from 30 Shore D to 50 Shore D.

Clause 40. The conduit according to any one of Clauses 1-39, wherein the composition is made in-reactor, in an extruder, or a combination thereof.

Clause 41. The conduit according to any one of Clauses 1-40, further comprising a corrosion protection coating directly applied to the outer surface of the steel pipe and bonded thereto, and underlying the first thermal insulation layer.

Clause 42. The conduit according to Clause 41, wherein the corrosion protection coating comprises a layer of cured epoxy or modified epoxy.

Clause 43. The conduit according to Clause 41, wherein the corrosion protection coating comprises an epoxy phenolic, a styrene-maleic anhydride copolymer such as a styrene-maleic anhydride copolymer blended with acrylonitrile-butadiene-styrene (ABS), polyphenylene sulphide, polyphenylene oxide or polyimide, including modified versions and blends thereof.

Clause 44. The conduit according to any one of Clauses 1-43, wherein the conduit is free of an adhesive.

Clause 45. The conduit according to any one of Clauses 1-44, wherein the corrosion protection coating comprises a single-layer composite corrosion protection coating directly applied to the outer surface of the steel pipe and bonded thereto and in direct contact with the first thermal insulation layer, wherein the single-layer composite corrosion protection coating comprises a cured epoxy resin, an adhesive and an unfoamed polymeric material.

Clause 46. The conduit according to any one of Clauses 1-45, further comprising an outer protective topcoat applied over the first thermal insulation layer and forming an outer surface of the insulated transport conduit, wherein the outer protective topcoat comprising an unfoamed polymeric material.

Clause 47. The conduit according to any one of Clauses 1-45, further comprising a second thermal insulation layer comprising a second composition in the form of a solid, a blown foam or a syntactic foam, the second composition comprising a rubber and a thermoplastic olefin.

Clause 48. The conduit according to Clause 47, wherein the second thermal insulation layer comprises a material which is dissimilar to the composition of the first thermal insulation layer.

Clause 49. The conduit according to Clause 48, wherein the dissimilar polymeric material is selected from one or more members of the group consisting of solid or foamed polypropylene homopolymer or copolymer, polybutylene, polyethylene; polystyrene, high impact polystyrene, modified polystyrene, and crosslinked or partially crosslinked polypropylene and polyethylenes, including copolymers, blends and elastomers thereof; and wherein the first thermal insulation layer underlies the second thermal insulation layer.

Clause 50. The conduit according to any one of Clauses 1-49, wherein the conduit is a non-flexible pipe.

Clause 51. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a corrosion protection coating directly applied to the outer surface of the steel pipe and bonded thereto and underlying the first thermal insulation layer, wherein the first thermal insulation layer is in direct contact with the corrosion protection coating and directly adhered thereto.

Clause 52. The conduit of Clause 51, wherein the conduit is free of an adhesive.

Clause 53. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a corrosion protection coating directly applied to the outer surface of the steel pipe and bonded thereto, and underlying the first thermal insulation layer, wherein the corrosion protection coating comprises a multi-layer corrosion protection system applied to the outer surface of the steel pipe and underlying the first thermal insulation layer, wherein the multi-layer corrosion protection system comprises:
a layer of cured epoxy or modified epoxy directly applied to the outer surface of the steel pipe and bonded thereto; and
a first adhesive layer applied directly to the corrosion protection layer and underlying at least a portion the first thermal insulation layer.

Clause 54. The conduit according to Clause 53, wherein the adhesive layer comprises a polymer provided with functional groups and having a mutual affinity for the corrosion protection layer and the first thermal insulation layer.

Clause 55. The conduit according to Clause 53 or Clause 54, wherein the first thermal insulation layer is in direct contact with the first adhesive layer and is bonded thereto.

Clause 56. The conduit according to any one of Clauses 53-55, wherein the multi-layer corrosion protection system further comprises:

a first protective topcoat comprising an unfoamed polymeric material in direct contact with the first adhesive layer and bonded thereto, wherein the first thermal insulation layer is in direct contact with the first protective topcoat and bonded thereto.

Clause 57. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

an outer protective topcoat applied over the first thermal insulation layer and forming an outer surface of the insulated transport conduit, wherein the outer protective topcoat comprises an unfoamed polymeric material, and wherein the first thermal insulation layer is in direct contact with the outer protective topcoat and directly adhered thereto.

Clause 58. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a second thermal insulation layer comprising a second composition in the form of a solid, a blown foam or a syntactic foam, the second composition comprising a rubber and a thermoplastic olefin, wherein the first and second thermal insulation layers are foamed to different degrees.

Clause 59. The conduit according to Clause 58, wherein the first thermal insulation layer underlies the second thermal insulation layer, and wherein the second thermal insulation layer is foamed to a greater degree than the first thermal insulation layer.

Clause 60. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a second thermal insulation layer comprising a second composition in the form of a solid, a blown foam or a syntactic foam, the second composition comprising a rubber and a thermoplastic olefin,

wherein the first and second thermal insulation layers are foamed to different degrees,

wherein the first thermal insulation layer underlies the second thermal insulation layer, and is in direct contact with the second thermal insulation layer and directly adhered thereto.

Clause 61. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a second thermal insulation layer comprising a second composition in the form of a solid, a blown foam or a syntactic foam, the second composition comprising a rubber and a thermoplastic olefin, wherein the first and second thermal insulation layers are separated by a layer of unfoamed polymeric material.

Clause 62. The conduit according to claim 61, wherein interlayer adhesion is provided between the layer of unfoamed polymeric material and the first and second thermal insulation layers by treating the first thermal insulation layer with plasma or corona discharge prior to application of the layer of unfoamed polymeric material, and by plasma or corona discharge of the layer of unfoamed polymeric material prior to application of the second thermal insulation layer.

Clause 63. The conduit according to Clause 61 or Clause 62, wherein an adhesive layer is provided between the layer of unfoamed polymeric material and one or both of the first and second thermal insulation layers.

Clause 64. The conduit according to any one of Clauses 61-63, wherein the unfoamed polymeric material is an adhesive.

Clause 65. An insulated high-temperature transport conduit comprising:

a continuous steel pipe comprising one or more pipe sections, wherein the steel pipe has an outer surface and an inner surface;

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin; and

a molded pipe joint insulation system directly bonded to both the corrosion protection coating system and first thermal insulation layer at a joint connecting two pipe sections.

Clause 66. The conduit according to claim 65, wherein the molded pipe joint insulation system comprises a second composition, the second composition comprising a rubber and a thermoplastic olefin.

Clause 67. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin, the rubber is at least partially crosslinked.

Clause 68. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin, the rubber is substantially free of crosslinks.

Clause 69. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein the first thermal insulation layer comprises a composition that is resistant to degradation in hot water, the hot water being at a temperature greater than 100° C., the composition comprising a rubber and a thermoplastic olefin.

Clause 70. The conduit according to Clause 69, wherein the hot water is at a temperature of from 140° C. to 150° C.

Clause 71. The conduit according to Clause 69 or Clause 70, wherein the first thermal insulation layer has a long term temperature withstand capability of greater than 130° C.

Clause 72. The conduit according to any one of Clauses 69-71, wherein the composition is free of glass microspheres and ceramic microspheres.

Clause 73. The conduit according to any one of Clauses 69-72, wherein the composition comprises glass microspheres, ceramic microspheres, or a combination thereof.

Clause 74. The conduit according to any one of Clauses 69-73, wherein the composition has one or more of the following properties:

a thermal conductivity of 0.18 W/m·K or less at 25° C., as measured according to ASTM C518;

a specific heat capacity of greater than 2500 J/kg·K at 110° C., as measured according to ASTM E1269;

a water absorption of 3% or less at room temperature (such as from 20-25° C.) for 28 days, as measured according to ASTM D570;

a density of from 0.91 g/cm³ to about 0.94 g/cm³, as measured according to ISO 1183;

a homogenous tensile of 10 MPa or more at room temperature (such as from 20-25° C.), as measured according to ISO 37;

a jointed tensile of 5 MPa or more at room temperature (such as from 20-25° C.), as measured according to ISO 37;

a Shore hardness of from 20 Shore D to 50 Shore D, as measured according to ISO 868;

a glass transition temperature (Tg) of −25° C. or lower, as determined by differential scanning calorimetry according to ASTM E1356;

a compressive strength of 50 MPa or more at 23° C., as measured according to ASTM D575; or

a coefficient of linear thermal expansion of 50 μm/m·° C. or more, as measured according to ASTM E831.

Clause 75. The conduit according to any one of Clauses 69-74, wherein the composition has all of said properties of claim 74.

Clause 76. The conduit according to Clause 74 or Clause 75, wherein the thermal conductivity of the composition is from about 0.15 W/m·K to about 0.17 W/m·K at 25° C.

Clause 77. The conduit according to any one of Clauses 74-76, wherein the specific heat capacity of the composition is from about 3000 J/kg·K to about 3500 J/kg·K.

Clause 78. The conduit according to any one of Clauses 74-77, wherein the water absorption of the composition is 2% or less.

Clause 79. The conduit according to any one of Clauses 74-78, wherein the density of the composition is from about 0.92 g/cm³ to about 0.935 g/cm³.

Clause 80. The conduit according to any one of Clauses 74-79, wherein the homogenous tensile of the composition is from about 12 MPa to about 20 MPa.

Clause 81. The conduit according to any one of Clauses 74-80, wherein the jointed tensile of the composition is from about 5 MPa to about 15 MPa.

Clause 82. The conduit according to any one of Clauses 74-81, wherein the Shore hardness of the composition is from about 30 Shore D to about 40 Shore D.

Clause 83. The conduit according to any one of Clauses 74-82, wherein the Tg of the composition is −50° C. or lower.

Clause 84. The conduit according to any one of Clauses 74-83, wherein the compressive strength of the composition is about 100 MPa or more.

Clause 85. The conduit according to any one of Clauses 74-84, wherein the coefficient of linear thermal expansion of the composition is about 100 μm/m·° C. or more.

Clause 86. An insulated high-temperature transport conduit comprising:

a continuous steel pipe comprising one or more pipe sections, wherein the steel pipe has an outer surface and an inner surface; and

a first thermal insulation layer disposed over the outer surface of the steel pipe, wherein:
the first thermal insulation layer comprises a composition that is resistant to degradation in hot water, the hot water being at a temperature greater than 100° C.,
the composition comprising a rubber and a thermoplastic olefin, and the composition is free of glass microspheres and ceramic microspheres.

Clause 87. The conduit according to any one of Clauses 1-86, wherein the conduit is for use in subsurface environments.

Clause 88. The conduit according to any one of Clauses 1-87, wherein the conduit is for use in offshore, deep water environments.

Clause 89. A thermoplastic vulcanizate composition comprising an isobutylene-paramethylstyrene rubber having a paramethylstyrene derived content of 0.5 wt % to 25 wt %, such as 2 wt % to 20 wt %, such as 7 wt % to 12 wt %, based on the total weight of the rubber and thermoplastic polyolefin (such as polypropylene), wherein the thermoplastic vulcanizate is at least partially cured.

Clause 90. The thermoplastic vulcanizate composition of Clause 89 used as an insulating layer as described in any of Clauses 1 to 88.

### Examples

The Tables below set forth the ingredients and amounts (parts per hundred rubber, phr) employed in each sample and the results of physical testing of the compositions of the present disclosures and comparative examples. Those samples that correspond with the present disclosure are designated with “Ex.,” and those that are comparative are designated with the letter “C.”

### Sample Preparation Using a Brabender Mixer

TPV preparation was carried out under nitrogen in a laboratory Brabender-Plasticorder (model EPL-V5502). The mixing bowls had a capacity of 85 ml with the cam-type rotors employed. The plastic was initially added to the mixing bowl that was heated to 180° C. and at 100 rpm rotor speed. After plastic melting (2 minutes), the rubber, inorganic additives, and processing oil were packed into the mixer. After homogenization of the molten polymer blend (in 3-4 minute a steady torque was obtained), the curative was added to the mix, which caused a rise in the motor torque.

Mixing was continued for about 4 more minutes, after which the molten TPV was removed from the mixer, and pressed when hot between Teflon plates into a sheet which was cooled, cut-up, and compression molded at about 400° F. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (140° F.). Dog-bones were cut out of the molded (aged at room temperature for 24 hours) plaque for tensile testing (0.16″ width, 1.1″ test length (not including tabs at end)).

TPO preparation was carried out in a similar procedure as that for the TPV composition, except that the addition of curative is omitted.

Thermal conductivity is measured according to ASTM C518. Young's Modulus, tensile strength at yield, tensile strength at break, homogenous tensile, and jointed tensile is measured according to ISO 37. Elongation at break is measured according to ISO37. Water absorption is measured according to ASTM D570, specific heat capacity is measured according to E1269, density is measured according to ISO 1183, hardness is measured according to ISO 868, compressive strength is measured according to ASTM D575, coefficient of linear thermal expansion is measured according to ASTM E831, and abrasion loss is measured according to ASTM D4060-14.

Dynamic mechanical thermal analysis (DMTA) is used to determine the material glass transition temperature on MCR 301. The frequency of temperature sweep is 0.1 Hz, deformation is set at 2%, temperature range at −80° C. to 140° C. at increasing temperature ramp of 2° C./min. The test sample was cut from 4 mm thick tape.

Creep strain was measured by conditioning the test samples according to ASTM Lab conditions at 23±2° C. and 50±10% relative humidity. Conditioning time was not less than 40 hours under lab conditions and was not less than 48 hours after fabrication. Strips with dimensions of 15 mm width×250 mm length (0.591″ wide by 9.85″ long) were cut from compression molded sheet samples. The test area 100 mm was clamped and loaded with weights to achieve a total stress of 4 MPa. The creep strain was measured as a function of time for a week at 23° C.

Creep time was tested by applying a stress of 0.100 MPa was applied to the rectangular specimens with a dual cantilever fixture for twenty minutes at 20° C. and is reported in seconds (s) to achieve 10⁻⁸/Pa compliance by the DMA.

Table 1 shows example thermoplastic olefinic (TPO) compositions made according to the present disclosure versus a comparative TPV composition (C1). The TPO compositions (Examples 1 and 2) include a rubber phase that is uncured. The table includes ingredients and amounts (parts per hundred rubber, phr) employed in each sample and the results of physical testing of the examples and the comparative. EPDM(E)-1 is an ethylene propylene diene monomer rubber, where the diene is ethylidene norbornene, available from ExxonMobil of Houston, Tex. EPDM(E)-1 contains about 64 wt % ethylene, about 4.2 wt % ethylidenenorbornene, and about 75 phr extender oil. EPDM(V)-1 is an ethylene-propylene-ethylidene-norbornene rubber with a Mooney ML viscosity (1+4, 125° C.) of about 52. EPDM(V)-1 contains about 62 wt % ethylene, about 0.7 wt % vinyl norbornene, and about 100 phr extender oil. EPDM(V)-1 is available from ExxonMobil of Houston, Tex. EPDM(E)-2 is an ethylene-propylene-ethylidene-norbornene rubber with a Mooney ML viscosity (1+4, 125° C.) of about 147. PP1 is a polypropylene homopolymer having high melt strength and rigidity. Typical properties of PP1 include a nominal melt flow (230° C., 2.16 kg, ASTM D1238) of about 0.8, a tensile strength at yield (50 mm/min, ASTM D638) of about 36 MPa, a elongation at yield (50 mm/min, ASTM D638) of about 10%, and a flexural modulus (1.3 mm/min, ASTM D790A) of about 1310 MPa. EXP-PP is a high melt strength polypropylene described in US20180016414 and US20180051160. HMB-0221 is a siloxane slip agent (DOW-Corning™ HMB-0221 Masterbatch). The curative system includes a siloxane for hydrosilylation (Si—H) available from Dow Chemical, a platinum catalyst (in the form of a platinum catalyst concentrate), and zinc oxide. The Si—H is a reactive polysiloxane fluid, containing Si—H and alkyl groups, and has the properties of 0.8% SiH, a flash point of >100° C., and a viscosity (glass capillary, 25° C.) of about 9-30 cSt. The antioxidant package is calcium stearate and Irganox B4329.

SnCl₂ (MB) is an anhydrous stannous chloride polypropylene masterbatch. The SnCl₂ MB contains 45 wt % stannous chloride and 55 wt % of polypropylene having an MFR of 0.8 g/10 min (ASTM D1238; 230° C. and 2.16 kg weight). Zinc oxide (ZnO) is Kadox 911. Icecap K Clay is a filler.

TABLE 1
Comparative TPV Composition
versus Example TPO Compositions

| Formulations of | | | |
|---|---|---|---|
| the Compositions (phr) | | | |
| Material | C1 | Ex. 1 | Ex. 2 |
| EPDM(E)-1 | — | — | 175 |
| EPDM(V)-1 | 200 | 200 | — |
| PP1 | 515.4 | 490.4 | 451 |
| EXP-PP | — | — | — |
| HMB-0221 | — | 25 | — |
| Icecap K Clay | 12 | 12 | 42 |
| Si—H | 2.5 | — | — |
| Platinum catalyst | 0.007123 | — | — |
| Calcium Stearate/Irganox B4329 | 1.59 | 1.59 | — |
| ZnO | 2 | 2 | 2 |
| Paramount 6001R | 61 | 61 | 49.32 |
| Properties of the | | | |
| Compositions (phr) | | | |
| Hardness, Shore D | 46 | 45 | 47 |
| Stress @ 7%, MPa | 11.4 | 9.4 | 11.6 |
| Young's Modulus, MPa | 384 | 347 | 488 |
| Yield Strength, MPa | 14.0 | 11.6 | 13.3 |
| Yield Strain, % | 29.7 | 25.2 | 20.6 |
| Abrasion loss, mg/1000 cycle | 70 | 37 | 91 |
| Thermal conductivity, W/m · K | 0.188 | 0.181 | 0.188 |
| Creep strain (23° C., 4 MPa) | TBD | TBD | 8 |
| after 1 week, % | | | |

Table 1 illustrates that the TPO compositions perform as well as the comparative TPV composition based on the thermal conductivity.

Table 2 shows example TPO compositions made according to the present disclosure. The TPO compositions (Examples 3 and 4) include a rubber phase that is uncured. The table includes ingredients and amounts (parts per hundred rubber, phr) employed in each sample and the results of physical testing of the examples and the comparative. The butyl rubber in Table 2 is a brominated copolymer of isobutylene and paramethyl styrene having a specific gravity of 0.93, a bromine (benzylic) amount of 1.1 mol % (min) to 1.3 mol % (max.), and a Mooney viscosity (ML 1+8, 125° C., ASTM D1646) of 40 MU (min) to 50 MU (max.). PP2 is a polymer primary composed of isotactic propylene repeat units with random ethylene distribution, and is produced using a metallocene catalyst. Typical properties of PP2 include a density (ASTM D1505) of about 0.86 g/cm³, a melt index (190° C., 2.16 kg, ASTM D1238) of about 1.4 g/10 min, an MFR (230° C., 2.16 kg, ASTM D1238) of about 3, and an ethylene content of about 16 wt %. In some examples, two types of Indopol H-8 were used in some examples. Irganox, Irgafos, and Tinuvin are antioxidant/UV stabilizers.

TABLE 2
Formulation of Example TPO Compositions

| Material | Ex. 3 | Ex. 4 |
|---|---|---|
| Butyl Rubber | 100 | 100 |
| Icecap K Clay | 5 | 5 |
| PP5341 | 164 | 280 |
| PP2 | — | 3 |
| Irganox 3114 | 1 | 1 |
| Irgafos 168 | 2 | 2 |
| Tinuvin 622F | 2 | 2 |
| Paralux oil | — | 12 |
| Indopol H-8 | 42.3 | — |
| Indopol H-8 | 22 | — |
| Total Amount of Material | 338.3 | 405 |

In some examples, the thermal conductivity of the TPO compositions, having no cure was measured to be about 0.135 W/m·K. In contrast, the conventional material (a syntactic foam) is much higher at about 0.16 W/m·K. The examples (versus syntactic foam) show that TPO compositions can provide, at least, a reduction in the insulation layer thickness resulting in material cost savings and pipe light weighting. The exemplary compositions can also have superior extruder processability over syntactic foam and exhibit no issues due to crushing; that is, the TPO compositions can exhibit excellent properties, such as low initial thermal conductivity, high tensile modulus (Young's modulus), high compressive strength, high specific heat capacity, and the ability to withstand temperatures greater than 100° C.) for a longer period of time.

Table 3 shows example butyl rubber based TPV compositions made according to the present disclosure. Example 9 includes a Group II paraffinic oil plasticizer. The table includes ingredients and amounts (parts per hundred rubber, phr) employed in each sample and the results of physical testing of the examples and the comparative. The butyl rubber in Table 3 is a brominated copolymer of isobutylene and paramethyl styrene having a specific gravity of 0.93, a bromine (benzylic) amount of 1.1 mol % (min.) to 1.3 mol % (max.), and a Mooney viscosity (ML 1+8, 125° C., ASTM D1646) of 40 MU (min) to 50 MU (max.). PP2 is the same polymer as that provided above. PP5341 is described above. Oppanol N50, used here as a plasticizer, is a high molecular weight polyisobutylene (PIB) with a weight average MW of 565,000 g/mol available from BASF Corporation. Indopol H-100, used here as a plasticizer, is a low MW polyisobutylene available from Ineos.

TABLE 3
Butyl Rubber Based TPV Compositions
Formulations of the Compositions (phr)

| Material | Ex. 5 | Ex. 6 | Ex. 7 | Ex. 8 | Ex. 9 |
|---|---|---|---|---|---|
| Butyl Rubber | 100 | 100 | 100 | 100 | 100 |
| Icecap K Clay | 10 | 10 | 10 | 10 | 5 |
| Oppanol N50 | — | — | — | 30 | — |
| Stannous Chloride | 1.3 | 1.3 | 1.3 | 2 | — |
| Magnesium Oxide | 2 | 2 | 2 | 0.3 | — |
| Zinc Oxide | 2 | 2 | 2 | 2 | 5 |
| Stearic Acid | 1 | 1 | 1 | 2 | — |
| PP5341 | 164 | 164 | 164 | 280 | 164 |
| PP2 | — | — | — | 3 | — |
| Paramount 6001 | — | — | — | — | 54.5 |
| Resin SP-1045 | 3.5 | 3.5 | 3.5 | 2 | — |
| Irganox 3114 | — | — | 1 | 1 | — |
| Irgafos 168 | — | — | 2 | 2 | — |
| Tinuvin 622F | — | — | 2 | 2 | — |
| Paralux oil | — | — | — | 12 | — |
| Indopol H-8 | 41.1 | 64.3 | 64.3 | — | — |
| Indopol H-100 | 23.2 | — | — | — | — |
| Total Amount | 348.1 | 384.1 | 353.1 | 448.3 | 342.5 |

Properties of the Compositions

| | | | | | |
|---|---|---|---|---|---|
| Thermal conductivity | 0.14 | 0.14 | 0.14 | 0.16 | 0.16 |
| (at 23° C.), W/m · K | | | | | |
| Specific Gravity | 0.937 | 0.931 | 0.933 | 0.931 | 0.93 |
| Hardness, Shore D | 32 D | 38 D | 39 D | 48 D | 38 D |
| Tensile Strength at | 16.9 | 16.4 | 16.2 | 18.9 | 14 |
| Break (MPa) | | | | | |
| Elongation at Break (%) | 524 | 528 | 544 | 675 | 400 |
| Creep time to reach 10⁻⁸ | 1500 | 1500 | 1500 | 1500 | 2000 |
| compliance by DMTA | | | | | |
| (seconds) at 20° C. | | | | | |
| Young's Modulus | 218 | — | — | 599 | 151 |
| (MPa) @ 23° C. | | | | | |
| Young's Modulus | 134 | — | — | 294 | — |
| (MPa) @ 90° C. | | | | | |
| Compressive strength | — | — | — | — | 126 |
| @ 23° C. | | | | | |
| Coefficient of linear | — | — | — | — | 129 |
| thermal expansion | | | | | |
| (μm/m · ° C.) | | | | | |

Table 3 illustrates that for butyl rubber based TPV compositions, the addition of Indopol to the compositions resulted in a marked improvement in thermal conductivity.

Table 4 shows example EPDM rubber based TPV compositions with Group II paraffinic oil plasticizers made according to the present disclosure. The table includes ingredients and amounts (parts per hundred rubber, phr) employed in each sample and the results of physical testing of the examples and the comparative. EPDM(E)-1, EPDM(V)-1, PP1, and PP2 are described above. The curative system includes Si—H (described above), a platinum catalyst, stannous chloride, and zinc oxide. HRJ 16261 is a phenolic resin in oil. The antioxidant package is calcium stearate and Irganox B4329. Table 4 illustrates that the use of a Group II oil can influence the thermal conductivity and other properties of the compositions.

TABLE 4
Example TPV Compositions
Formulations of the Compositions (phr)

| Material | Ex. 10 | Ex. 11 | Ex. 12 |
|---|---|---|---|
| EPDM(E)-1 | 175 | — | — |
| EPDM (V)-1 | — | 200 | 200 |
| Icecap K Clay | 42 | 42 | 42 |
| Stannous Chloride | 1.67 | — | — |
| Zinc Oxide | 2 | 2 | 2 |
| PP1 | 451 | 200 | 515.4 |
| Paramount 6001 | 49.32 | 65 | 61 |
| HRJ 16261 | 12.82 | — | — |
| Si—H | — | 2.5 | 2.5 |
| Calcium Stearate/Irganox B4329 | — | 1.59 | 1.59 |
| Platinum catalyst | — | 0.007123 | 0.007123 |
| Total Amount | 733.8 | 513.1 | 824.5 |

Properties of the Compositions

| | | | |
|---|---|---|---|
| Thermal conductivity | 0.185 | 0.184 | 0.185 |
| (at 23° C.), W/m · K | | | |
| Specific Gravity | 0.931 | 0.933 | 0.921 |
| Hardness, Shore D | 48D | 30D | 46D |
| Tensile Strength at yield (MPa) | 12.9 | — | 14.0 |
| Young's Modulus (MPa) @ 23° C. | 434 | 76 | 384 |

Table 5 shows example EPDM rubber and butyl based TPV compositions with uncrosslinked rubber made according to the present disclosure. The table includes ingredients and amounts (parts per hundred rubber, phr) employed in each sample and the results of physical testing of the examples and the comparative. Table 5 illustrates that the thermal conductivity may be lowered by the use of uncrosslinked rubber.

TABLE 5
Example Compositions
Formulations of the Compositions (phr)

| Material | Ex. 13 | Ex. 14 | Ex. 15 |
|---|---|---|---|
| EPDM(E)-1 | 175 | — | — |
| Butyl Rubber | — | 100 | 100 |
| Icecap K Clay | 42 | 5 | 5 |
| Zinc Oxide | 2.00 | — | — |
| PP5341 | 451 | 164 | 280 |
| Paramount 6001 | 49.32 | | 12 |
| Irganox 3114 | — | 1 | 1 |
| Irgafos 168 | — | 2 | 2 |
| Tinuvin 622F | — | 2 | 2 |
| Indopol H8 | — | 64.3 | 1.59 |
| PP2 | — | — | 3 |
| Total Amount | 719.3 | 513.1 | 405.0 |

Properties of the Compositions

| | | | |
|---|---|---|---|
| Thermal conductivity (at 23° C.), W/m · K | 0.188 | 0.142 | 0.155 |
| Specific Gravity | 0.931 | 0.912 | 0.917 |
| Hardness, Shore D | 47D | 31D | 48D |
| Young's Modulus (MPa) @ 23° C. | 488 | 215 | 562 |

Table 6 shows example EPDM rubber and butyl based TPV compositions with uncrosslinked rubber made according to the present disclosure. The table includes ingredients and amounts (parts per hundred rubber, phr) employed in each sample and the results of physical testing of the examples and the comparative.

TABLE 6
Example Composition with uncrosslinked rubber
Formulations of the Composition (phr)

| Material | Ex. 16 |
|---|---|
| Butyl Rubber | 100 |
| PP5341 | 164 |
| Icecap K Clay | 5 |
| ZnO | 5 |
| HRJ 16261 | 14 |
| Paramount 6001 | 54.5 |
| Total Amount | 342 |

Properties of the Compositions

| Property | Test Method | Results |
|---|---|---|
| Thermal conductivity | ASTM C518 | 0.155 W/m · K at 25° C. |
| Specific heat capacity | ASTM E1269 | 3283 J/kg · K at 110° C. |
| Water absorption | ASTM D570 | 1% at room temp for 28 |
| days | | |
| Density | ISO 1183 | 0.93 g/cm³ |
| Homogenous tensile | ISO 37 | 16.6 MPa at room temp |
| Jointed tensile | ISO 37 | 7.6 MPa at room temp |
| Hardness | ISO 868 | 38 Shore D |
| Tg | | −59.9° C. |
| Compressive strength | ASTM D575 | 126 MPa at 23° C. |
| Coefficient of linear | ASTM E831 | 129 μm/m · ° C. |
| thermal expansion | | |

Tg was measured according to the method described above.

Table 7 shows example butyl based TPV compositions made from an isobutylene-paramethylstyrene rubber with a paramethylstyrene derived content in the range of 7 wt % to 12 wt % based on the total weight of the rubber. Talc is SG-2000 talc powder from Nippon Talc. Maglite D is magnesium oxide from HallStar. ESCOREZ 5320 is a commercially available hydrocarbon resin (ExxonMobil Chemical Company). SP1045 is a commercially available phenolic resin available from SI Group. Diak 4 is 4,4′-methylenebis(cyclohexylamine)carbamate available from Vanderbilt Chemicals. MF650Y is Metocene MF650Y polypropylene available from LyondellBassell. Oil added before curing is indicated in Table 7 as “(pre)” and oil added after 5 minutes of curing is indicated as “(post)”.

TABLE 7
Example of TPV Compositions
Formulations of the Compositions (phr)

| | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| | 17 | 18 | 19 | 20 | 21 | 22 | 23 | 24 | 25 | 26 | 27 | 28 | 29 |
| Butyl Rubber | 100 | 100 | 100 | 100 | 100 | 100 | 100 | 100 | 100 | 100 | 100 | 100 | 100 |
| MF650Y | — | — | — | — | — | — | — | — | — | — | 34 | — | — |
| Braskem F180A | — | — | — | — | — | — | 168 | — | — | 68 | 34 | — | — |
| PP5341 | 25 | 168 | 168 | 168 | 168 | 168 | — | 168 | 68 | — | — | 68 | 168 |
| Icecap clay | 4.8 | 10 | — | 10 | 40 | 10 | 10 | 10 | — | — | — | — | 10 |
| Talc | — | — | 10 | — | — | — | — | — | — | — | — | — | — |
| Paramount | — | — | — | 31.2 | — | 32.3 | — | — | — | — | — | — | — |
| 6001 (pre) | | | | | | | | | | | | | |
| Paramount | — | — | — | 22.6 | — | 32 | — | — | — | — | — | — | — |
| 6001 (post) | | | | | | | | | | | | | |
| Indopol | 30 | 32.3 | 32.3 | — | 32.3 | — | 32.3 | 32.3 | 32.3 | 32.3 | 32.3 | 32.3 | 32.3 |
| H100 (pre) | | | | | | | | | | | | | |
| Indopol | 34.3 | 32 | 32 | — | 32 | — | 32 | 32 | 32 | 32 | 32 | 32 | 32 |
| H100 (post) | | | | | | | | | | | | | |
| Stearic acid | 1 | 1 | 1 | 1 | 1 | 1 | 1 | — | 1 | 1 | 1 | 1 | — |
| SnCl2 | 1.3 | 1.3 | 1.3 | 1.3 | 1.3 | 1.3 | 1.3 | — | 1.3 | 1.3 | 1.3 | 1.3 | — |
| ZnO | 2 | 2 | 2 | 2 | 2 | 2 | 2 | 2 | 2 | 2 | 2 | 2 | — |
| Maglite D | 2 | 2 | 2 | 2 | 2 | 2 | 2 | — | 2 | 2 | 2 | 2 | — |
| Escorez 5320 | 16.5 | 16.5 | 16.5 | 16.5 | 16.5 | 16.5 | 16.5 | 16.5 | 16.5 | 16.5 | 16.5 | — | 16.5 |
| HRJ 16261 | — | — | — | 14 | — | — | — | — | — | — | — | — | — |
| SP1045 | 3.5 | 3.5 | 3.5 | — | 3.5 | 3.5 | 3.5 | 3.5 | 3.5 | 3.5 | 3.5 | 3.5 | — |
| Diak 4 | — | — | — | — | — | — | — | — | — | — | — | — | 1.75 |
| Total | 220.4 | 368.6 | 368.6 | 368.6 | 398.6 | 368.6 | 368.6 | 364.3 | 258.6 | 258.6 | 258.6 | 242.1 | 360.55 |
| Amount | | | | | | | | | | | | | |

Properties of the Compositions

| | | | | | | | | | | | | | |
|---|---|---|---|---|---|---|---|---|---|---|---|---|---|
| Specific gravity | 0.96 | 0.95 | 0.95 | 0.94 | 0.99 | 0.94 | 0.95 | 0.94 | 0.94 | 0.94 | 0.94 | 0.93 | 0.94 |
| (ISO 1183) | | | | | | | | | | | | | |
| Hardness | 39 A | 37 D | 37 D | 35 D | 38 D | 37 D | 37 D | 37 D | 75 A | 77 A | 77 A | 78 A | 39 D |
| (ISO 868) | | | | | | | | | | | | | |
| Tensile strength at | 4.5 | 13.5 | 13.3 | 15 | 14 | 14.6 | 14.2 | 14.1 | 9.3 | 8.6 | 7 | 8.8 | 10.7 |
| break (MPa, | | | | | | | | | | | | | |
| ASTM D412) | | | | | | | | | | | | | |
| Elongation | 362 | 428 | 407 | 441 | 479 | 387 | 457 | 457 | 438 | 395 | 422 | 379 | 363 |
| at break (%, | | | | | | | | | | | | | |
| ASTM D412) | | | | | | | | | | | | | |
| Strength at | 1.2 | 9.3 | 9.4 | 8.9 | 9.3 | 9.3 | 9.5 | 9.4 | 4.1 | 4.2 | 3.8 | 4.4 | 9 |
| 100% elongation | | | | | | | | | | | | | |
| (MPa, ASTM | | | | | | | | | | | | | |
| D412) | | | | | | | | | | | | | |
| Weight gain in | 88.5 | 20.8 | 22.6 | 21.7 | 20.9 | 21.6 | 22.3 | 19.7 | 52.9 | 49.8 | 54.5 | 46.3 | 25.3 |
| IRM903 (%, 24 hr | | | | | | | | | | | | | |
| @ 121 oC., TPE | | | | | | | | | | | | | |
| 0145/1) | | | | | | | | | | | | | |
| Tension set (%, | 4 | 43.5 | 44.3 | 36 | 43.8 | 36.8 | 43 | 45.2 | 20.2 | 19 | 22.8 | 20.8 | 46.8 |
| 100% elongation, | | | | | | | | | | | | | |
| 10 min at RT, | | | | | | | | | | | | | |
| release 10 min, | | | | | | | | | | | | | |
| TPE 0053) | | | | | | | | | | | | | |

The results show that the TPV and TPO compositions made according to the present disclosure can have excellent properties to insulate oil and gas pipelines such as excellent thermal conductivity of <0.2 W/(m K), a small change of thermal conductivity under heat and seawater exposure, high tensile modulus (>300 MPa), high compressive strength (>10 MPa), high specific heat capacity (>1300 J/kg·K), and have the ability to withstand temperature >100° C.

The results also show that the TPV and TPO compositions can be used in an external coating positioned as thermal insulation material around non-flexible pipes conveying oil and/or gas production in submerged water service for flow assurance purposes. The TPV and TPO compositions can have better thermal insulation properties than glass-syntactic polypropylene or pure polypropylene, which translates to thinner insulation layers and consequent reduction of pipe outer diameter and pipe laying cost. The thermal properties of the TPV and TPO compositions of the present disclosure can be achieved without the addition of glass microspheres thus addressing the aforementioned related limitations of glass-syntactic polypropylene and polyurethane systems. The TPV and TPO compositions of the present disclosure can have lower thermal conductivity without utilizing glass microspheres, a higher tensile elongation property, and a lower, low-temperature flexibility limit, which can be a benefit to non-flexible pipes in subsea oil field applications as thermal insulation material.

The TPV and TPO compositions can have a substantially higher tensile elongation property than glass-syntactic polypropylene and polyurethane systems and can maintain this property to a temperature substantially below minimum ambient temperatures possible during reel-lay, thus reducing susceptibility to cracking at or near the interface between the factory-applied material on the pipe body and the field-applied material over welded joints. The results also show that the TPV and TPO compositions can be resistant to degradation in hot water, such as at temperatures of from about 140° C. to about 150° C. In contrast, conventional glass-syntactic polyurethane is resistant to temperatures of less than 100° C. Although conventional glass-syntactic polypropylene can be resistant to degradation at temperatures approaching 140° C.-150° C., the TPV and TPO compositions of the present disclosure do not suffer from the same problems seen with glass-syntactic polypropylene and can have a longer lifetime than conventional glass-syntactic polypropylene.

Some compositions described herein can include a high temperature resistant thermoplastic olefin that provides good thermal conductivity properties. Some compositions described herein can deliver very low thermal conductivity by selection of the rubber phase. For example, a very low thermal conductivity can be obtained when using butyl rubber as the rubber phase. In addition, the compositions described herein can show substantial low temperature crack resistance over conventional thermoplastics.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

1-86. (canceled)

87. An insulated high-temperature transport conduit comprising:
a continuous steel pipe comprising one or more pipe sections, wherein the steel pipe has an outer surface and an inner surface; and
a first thermal insulation layer disposed over the outer surface of the steel pipe, wherein the first thermal insulation layer comprises a composition having a thermal conductivity of less than 0.2 W/m·K, the composition comprising a rubber and a thermoplastic olefin.

88. The conduit according to claim 87, wherein the composition has a Vicat softening point of from 90° C. to 200° C.

89. The conduit according to claim 87, wherein the composition has a Shore hardness of from 30 Shore D to 50 Shore D.

90. The conduit according to claim 87, wherein the first thermal insulation layer has one or more of the following properties:
a creep resistance of less than 7%;
a Young's modulus at 23° C. of 50 MPa or more;
a compressive strength at 23° C. of 10 MPa or more, as measured according to ASTM D575;
a specific heat capacity at 110° C. of 1300 J/kg·K or more, as measured according to ASTM E1269.

91. The conduit according to claim 87, wherein the first thermal insulation layer has a long term temperature withstand capability of >130° C.

92. The conduit according to claim 87, wherein the thermoplastic olefin is selected from the group consisting of polypropylene, polyethylene, syndiotactic polystyrene, cyclic olefin copolymer, polyphenylene oxide (PPO) blended with polypropylene, polybutylene terephthalate, polyethylene terephthalate, acrylonitrile butadiene styrene, acrylonitrile styrene acrylate, polyetherimide, polyamide, polymethylpentene polymethylpentene resin, and a combination thereof.

93. The conduit according to claim 92,
wherein the cyclic olefin copolymer comprises norbornene in the range of from about 60 wt % to about 90 wt % and ethylene;
wherein the cyclic olefin copolymer has a glass transition temperature of from about 40° C. to about 200° C.; and/or
wherein the cyclic olefin copolymer has an MFR (260° C., 2.16 kg) of from about 1 ml/10 min to about 60 ml/10 min.

94. The conduit according to claim 87, wherein the thermoplastic olefin is polyphenylene oxide or a polyphenylene oxide blended with polypropylene, polystyrene or polyamide.

95. The conduit according to claim 87, wherein the thermoplastic olefin is one or more of a polypropylene, a polyethylene, and a polybutene-1.

96. The conduit according to claim 87, wherein the thermoplastic olefin is a polypropylene homopolymer, polypropylene random copolymer, or an impact copolymer polypropylene.

97. The conduit according to claim 87, wherein the thermoplastic olefin is a polypropylene having a MFR from 0.1 to 10 g/10 min and/or a Mw of from 100,000 to 1,000,000 g/mol.

98. The conduit according to claim 87, wherein the thermoplastic olefin is a high melt strength (HMS) long chain branched (LCB) homopolymer PP.

99. The conduit according to claim 87, wherein the thermoplastic olefin has a Vicat softening point of from 100 to 200° C.

100. The conduit according to claim 87, wherein the thermoplastic olefin has a thermal conductivity of no greater than 0.22 W/m·K.

101. The conduit according to claim 87, wherein the rubber is at least partially crosslinked.

102. The conduit according to claim 87, wherein the rubber has a Mw of from 100,000 g/mol to 3,000,000 g/mol.

103. The conduit according to claim 87, wherein the rubber is one or more of a nitrile rubber or a butyl rubber.

104. The conduit according to claim 87, wherein the rubber is a butyl rubber selected from the group consisting of isobutylene-isoprene rubber (IIR), brominated isobutylene-isoprene rubber (BIIR), and isobutylene paramethyl styrene rubber (BIMSM).

105. The conduit according to claim 104, wherein the butyl rubber is an isobutylene-paramethylstyrene rubber comprising from 0.5 wt % to 25 wt % paramethylstyrene based on an entire weight of the rubber.

106. The conduit according to claim 104, wherein the butyl rubber is a brominated isobutylene-isoprene rubber comprising a percent by weight halogenation of from 0.3 wt % to 7 wt % based on an entire weight of the rubber.

107. The conduit according to claim 87, wherein the composition has a concentration of rubber of from 5 wt % to 50 wt %, and a thermoplastic olefin, based on a combined weight of the rubber and the thermoplastic olefin, and a concentration of the thermoplastic olefin of from 50 wt % to 95 wt % based on the combined weight of the rubber and the thermoplastic olefin, wherein the combined weight of rubber and thermoplastic olefin does not exceed 100 wt %.

108. The conduit according to claim 87, wherein the composition further comprises a plasticizer.

109. The conduit according to claim 108, wherein the plasticizer is selected from the group consisting of paraffinic oil, low molecular weight ester plasticizer, polyisobutylene, synthetic oil, triisononyl trimellitate, and a combination thereof.

110. The conduit according to claim 108, wherein the plasticizer is a paraffinic oil, synthetic oil, PIB, polybutene, or alklyl ester, or a combination thereof.

111. The conduit according to claim 108, wherein the plasticizer is a liquid polyisobutylene oil having Mn in the range from about 200 to 6000; and, from 20 to 100 phr (parts by weight per 100 parts of block copolymer) of polyolefin hardener.

112. The conduit according to claim 108, wherein the plasticizer is a paraffinic oil.

113. The conduit according to claim 87, wherein the composition further comprises a cure system.

114. The conduit according to claim 113, wherein the cure system comprises a phenolic resin, a peroxide, a maleimide, a hexamethylene diamine carbamate, a silicon-based curative, a silane-based curative, a sulfur-based curative, or a combination thereof.

115. The conduit according to claim 113, wherein the cure system comprises at least one of a hydrosilylation curative, a hydro-siloxane curative, a phenolic resin curative, or a metal oxide.

116. The conduit according to claim 87, wherein the composition further comprises at least one of a filler and a nucleating agent.

117. The conduit according to claim 87, wherein the composition further comprises hollow microspheres.

118. The conduit according to claim 87, wherein the composition further comprises calcium carbonate, clay, silica, talc, titanium dioxide, carbon black, mica, wood flour, or a combination thereof.

119. The conduit according to claim 87, wherein the composition further comprises a siloxane based slip agent.

120. The conduit according to claim 87, wherein the composition further comprises a high density polyethylene (HDPE) and/or a high modulus polyethylene (HMPE).

121. The conduit according to claim 87, further comprising a corrosion protection coating directly applied to the outer surface of the steel pipe and bonded thereto, and underlying the first thermal insulation layer.

122. The conduit according to claim 121, wherein the corrosion protection coating comprises a layer of cured epoxy or modified epoxy.

123. The conduit according to claim 121, wherein the corrosion protection coating comprises an epoxy phenolic, a styrene-maleic anhydride copolymer, polyphenylene sulphide, polyphenylene oxide or polyimide, including modified versions and blends thereof.

124. The conduit according to claim 121, wherein the corrosion protection coating comprises a single-layer composite corrosion protection coating directly applied to the outer surface of the steel pipe and bonded thereto and in direct contact with the first thermal insulation layer, wherein the single-layer composite corrosion protection coating comprises a cured epoxy resin, an adhesive and an unfoamed polymeric material.

125. The conduit according to claim 87, further comprising an outer protective topcoat applied over the first thermal insulation layer and forming an outer surface of the insulated transport conduit, wherein the outer protective topcoat comprising an unfoamed polymeric material.

126. The conduit according to claim 87, further comprising a second thermal insulation layer comprising a second composition in the form of a solid, a blown foam or a syntactic foam, the second composition comprising a rubber and a thermoplastic olefin.

127. The conduit according to claim 126, wherein the second thermal insulation layer comprises a material which is dissimilar to the composition of the first thermal insulation layer.

128. The conduit according to claim 127, wherein the dissimilar polymeric material is selected from one or more members of the group consisting of solid or foamed polypropylene homopolymer or copolymer, polybutylene, polyethylene; polystyrene, high impact polystyrene, modified polystyrene, and crosslinked or partially crosslinked polypropylene and polyethylenes, including copolymers, blends and elastomers thereof; and wherein the first thermal insulation layer underlies the second thermal insulation layer.
